(19) United States
(12) Patent Application Publication
(10) Pub. No.: US 2026/0056450 A1
(43) Pub. Date: Feb. 26, 2026

(54) SELFIE STICK CONVENIENT FOR BEING OPERATED WITH INDEX FINGER, AND SELFIE STICK

(71) Applicant: SHENZHEN INTELLIARK TECHNOLOGY CO., LTD, SHENZHEN (CN)

(72) Inventor: YUNCHENG DAI, SHENZHEN (CN)

(21) Appl. No.: 19/206,348

(22) Filed: May 13, 2025

(30) Foreign Application Priority Data
Aug. 22, 2024 (CN) 202422051323.5
Mar. 11, 2025 (CN) 202520420367.2
Mar. 31, 2025 (CN) 202520597846.1
Apr. 21, 2025 (CN) 202520765026.9

(51) Int. Cl. G03B 17/56; F16M 11/28; G03B 7/26

(52) U.S. Cl. CPC G03B 17/561; F16M 11/28; G03B 7/26

(57) ABSTRACT

A selfie stick convenient for being operated with an index finger includes a clamping assembly, a supporting member, an extension and retraction mechanism, a handle and a shutter button. The clamping assembly having a main surface for facing the external equipment located on a first side. A step part is arranged on a surface of the handle located on the second side; the step part includes a first surface. From one side close to the second connecting part to one side away from the second connecting part, a distance between at least a portion of the first surface and an axis of the handle gradually increases. The shutter button is arranged on the first surface and configured to be operated with the index finger of the user to control the external equipment to take a photo.

### CROSS-REFERENCE TO RELATED APPLICATIONS

The application claims priorities of Chinese Patent Application No. CN202422051323.5, filed on Aug. 22, 2024, Chinese Patent Application No.CN202520420367.2, filed on Mar. 11, 2025, Chinese Patent Application No.CN202520597846.1, filed on Mar. 31, 2025, and Chinese Patent Application No.CN202520765026.9, filed on Apr. 21, 2025, the entire contents of which are incorporated herein by reference.

### TECHNICAL FIELD

The present invention relates to the technical field of supporting structures, and in particular, to a selfie stick convenient for being operated with an index finger, and a selfie stick.

### BACKGROUND

With the population of smart electronic products such as mobile phones, people can take photos anytime and anywhere, especially take selfies. Therefore, there are many types of auxiliary photo-taking devices (such as selfie sticks) on the market, which enable people to take better selfies in various places and make the selfies more beautiful.

However, with the development of selfie stick technologies, a selfie stick product is designed to have an increasingly large volume and becomes heavier, which makes it difficult for a user to hold and use the selfie stick. Since a shutter control switch of the selfie stick on the market is arranged on a front surface of the selfie stick, namely a side surface facing the user, it is inconvenient for the user to control the shutter control switch when the user holds the selfie stick to take a photo. Pressing the switch with the thumb can cause the selfie stick to shake easily during photo taking, which affects the photo-taking experience.

### SUMMARY

In order to overcome the shortcomings of the prior art, the present invention provides a selfie stick convenient for being operated with an index finger, and a selfie stick, so as to make the operation convenient.

In the first aspect, the present invention discloses a selfie stick convenient for being operated with an index finger, which is configured to support external equipment to take a photo, and includes a clamping assembly, a supporting member, an extension and retraction mechanism, a handle and a shutter button.

The clamping assembly having a main surface for facing the external equipment located on a first side. A surface of the clamping assembly located on a second side faces away from the main surface.

The supporting member includes a base and a first connecting part connected to the base. One end of the base away from the first connecting part is connected to the clamping assembly.

The extension and retraction mechanism includes an extendable arm and a second connecting part arranged at one end of the extendable arm. The second connecting part is connected to the first connecting part, and the extendable arm is capable of extending and retracting to adjust a length of the selfie stick.

The handle connected to one end of the extendable arm away from the second connecting part for holding, a step part is arranged on a surface of the handle located on the second side; the step part is a protruding structure that protrudes towards the second side; the step part includes a first surface for abutting against the index finger of a user; the first surface is at least a portion of a surface of the step part close to the second connecting part.

From one side close to the second connecting part to one side away from the second connecting part, a distance between at least a portion of the first surface and an axis of the handle gradually increases, or the first surface is perpendicular to the axis of the handle.

The shutter button is arranged on the first surface and configured to be operated with the index finger of the user to control the external equipment to take a photo.

Compared with the prior art, the selfie stick convenient for being operated with the index finger provided in the present invention has the advantages that the step part is arranged on the second side of the handle, and the shutter button is arranged on the first surface of the step part close to the second connecting part. In this way, when the user holds the handle in the palm, since the step part is always opposite to the main surface of the clamping assembly, the index finger can abut against the step part. During use, the user can touch or press the shutter button if the user applies a low force slightly with the index finger, thus taking a photo. Then, the impact on a photo-taking effect caused by shaking of the selfie stick due to a large range of motion of the finger of the user can be avoided, and the user experience can be enhanced. From one side close to the second connecting part to one side away from the second connecting part, a distance between at least a portion of the first surface and the axis of the handle gradually increases. Alternatively, the first surface is perpendicular to the axis of the handle. In this way, when the user presses the shutter button with the index finger, the first surface can provide sufficient support for the index finger of the user to improve the convenience and comfort level of the user in pressing the shutter button.

In the second aspect, the present invention also discloses a selfie stick, which includes a handle, a connecting mechanism and a locking assembly.

The handle for being held by a user.

The connecting mechanism is configured to mount external equipment and rotatably connected to the handle, to enable the connecting mechanism and the handle to switch between an unfolded use state and a folded storage state.

The locking assembly is arranged on the connecting mechanism and the handle. The locking assembly is configured to lock the connecting mechanism to the handle when the connecting mechanism and the handle are in the storage state.

Based on the selfie stick in this embodiment of the present invention, the connecting mechanism and the handle are connected by the locking assembly, so that relative position fixation between the connecting mechanism and the handle can be achieved when the connecting mechanism and the handle are in the folded storage state. The connecting mechanism and the handle cannot be opened freely, to facilitate storage.

### BRIEF DESCRIPTION OF THE DRAWINGS

In order to explain the technical solutions of the embodiments of the present invention more clearly, the following will briefly introduce the accompanying drawings used in the embodiments. The drawings in the following description are only some embodiments of the present invention. Those of ordinary skill in the art can obtain other drawings based on these drawings without creative work.

The present invention is further described below in detail in combination with the accompanying drawings and embodiments.

FIG. 1 is a schematic structural diagram of a selfie stick according to a first embodiment of the present invention;

FIG. 2 is a schematic side view of the selfie stick shown in FIG. 1;

FIG. 3 is a schematic structural diagram of a change embodiment of the selfie stick shown in FIG. 1;

FIG. 4A is a side view of a specific shape of a step part in a first case of the present invention;

FIG. 4B is a side view of another specific shape of a step part in a first case of the present invention;

FIG. 5A is a side view of a side view of a specific shape of a step part in a second case of the present invention;

FIG. 5B is a side view of another specific shape of a step part in a second case of the present invention;

FIG. 6A is a side view of a specific shape of a step part in a third case of the present invention;

FIG. 6B is a side view of another specific shape of a step part in a third case of the present invention;

FIG. 6C is a side view of still another specific shape of a step part in a third case of the present invention;

FIG. 6D is a side view of yet another specific shape of a step part in a third case of the present invention;

FIG. 7A is a side view of a specific shape of a step part in a fourth case of the present invention;

FIG. 7B is a side view of another specific shape of a step part in a fourth case of the present invention;

FIG. 7C is a side view of a still another specific shape of a step part in a fourth case of the present invention;

FIG. 8A is a side view of a specific shape of a step part in a fifth case of the present invention;

FIG. 8B is a side view of another specific shape of a step part in a fifth case of the present invention;

FIG. 8C is a side view of still another specific shape of a step part in a fifth case of the present invention;

FIG. 8D is a side view of yet another specific shape of a step part in a fifth case of the present invention;

FIG. 8E is a side view of still yet another specific shape of a step part in a fifth case of the present invention;

FIG. 9 is a schematic structural diagram of a second portion of a step part and a first portion of a step part being not removed according to an embodiment of the present invention;

FIG. 10 is a schematic structural diagram of a second portion of a step part and a first portion of a step part being removed according to an embodiment of the present invention;

FIG. 11 is a schematic structural diagram of a connecting mechanism and a handle being folded according to a second embodiment of the present invention;

FIG. 12 is a schematic structural diagram of the connecting mechanism and the handle in FIG. 11 being unfolded;

FIG. 13 is a schematic structural diagram of the selfie stick in FIG. 11 being in an open state;

FIG. 14 is a schematic structural diagram of the selfie stick in FIG. 11 being in a use state;

FIG. 15 is a schematic structural diagram of a connecting mechanism and a handle being folded in a change embodiment of the selfie stick shown in FIG. 11;

FIG. 16 is a schematic structural diagram of the connecting mechanism and the handle in FIG. 15 being unfolded;

FIG. 17 is a schematic structural diagram of a connecting mechanism and a handle being folded in another change embodiment of the selfie stick shown in FIG. 11;

FIG. 18 is a schematic structural diagram of the connecting mechanism and the handle in FIG. 17 being unfolded;

FIG. 19 is a schematic structural diagram of a connecting mechanism and a handle being folded in still another change embodiment of the selfie stick shown in FIG. 11;

FIG. 20 is a schematic structural diagram of the connecting mechanism and the handle in FIG. 19 being unfolded;

FIG. 21 is a schematic structural diagram of the selfie stick in FIG. 19 being in an open state;

FIG. 22 is a schematic structural diagram of a selfie stick according to a third embodiment of the present invention, in a case that a step part is arranged at a third connecting part;

FIG. 23 is a schematic diagram of an exploded structure of FIG. 22;

FIG. 24 is a schematic structural diagram of the selfie stick in FIG. 22 using a step part in another pattern of manifestation;

FIG. 25 is a schematic structural diagram of the selfie stick in FIG. 22 using a step part in still another pattern of manifestation;

FIG. 26 is a schematic structural diagram of a selfie stick according to a third embodiment of the present invention, in a case that a step part is arranged on a supporting leg;

FIG. 27 is a schematic structural diagram of the selfie stick in FIG. 26 using a step part in another pattern of manifestation;

FIG. 28 is a schematic structural diagram of the selfie stick in FIG. 27 using a step part in still another pattern of manifestation;

FIG. 29 is a schematic structural diagram of a selfie stick according to a fourth embodiment of the present invention;

FIG. 30 is a schematic structural diagram of the selfie stick in FIG. 29 in another viewing angle;

FIG. 31 is a schematic diagram of an exploded structure of FIG. 29;

FIG. 32 is a schematic structural diagram of a supporting member, which rotates relative to the handle, of the selfie stick in FIG. 29;

FIG. 33 is a schematic structural diagram of an extendable arm, which extends, of the selfie stick in FIG. 29;

FIG. 34 is a schematic structural diagram of a supporting leg of a selfie stick being in a storage state according to an embodiment of the present disclosure;

FIG. 35 is a schematic structural diagram of the selfie stick in FIG. 34 in another viewing angle;

FIG. 36 is a schematic structural diagram of a supporting leg of a selfie stick being in a supporting state according to an embodiment of the present disclosure;

FIG. 37 is a schematic diagram of a partial sectional structure of a selfie stick in which a storage leg is in a storage state according to an embodiment of the present disclosure;

FIG. 38 is a schematic diagram of an enlarged structure of part A in FIG. 37;

FIG. 39 is a schematic diagram of a partial sectional structure of a selfie stick in which a supporting leg is in a storage state according to an embodiment of the present disclosure;

FIG. 40 is a schematic diagram of an enlarged structure of part B in FIG. 39;

FIG. 41 is a schematic structural diagram of an end wall according to an embodiment of the present disclosure;

FIG. 42 is a schematic structural diagram of a supporting leg according to an embodiment of the present disclosure;

FIG. 43 is a schematic diagram of a sectional structure of a selfie stick in which a storage leg is in a storage state according to an embodiment of the present disclosure;

FIG. 44 is a schematic diagram of an enlarged structure of part C in FIG. 43;

FIG. 45 is a schematic structural diagram of a handle and a connecting mechanism being in an unfolded use state according to an embodiment of the present disclosure; and

FIG. 46 is a schematic structural diagram of a selfie stick being in a photographing state according to an embodiment of the present disclosure.

### DETAILED DESCRIPTION OF THE EMBODIMENTS

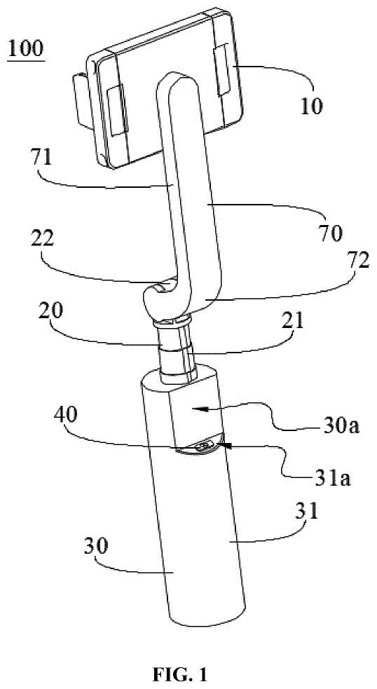

As shown in FIG. 1, a first embodiment of the present invention provides a selfie stick 100 convenient for being operated with an index finger. The selfie stick 100 is configured to support external equipment 200 (not shown in the drawing of Embodiment I. Refer to FIG. 14 of Embodiment II) to take a photo. The external equipment 200 includes an electronic device with a camera function such as a mobile phone, a tablet computer, and a camera.

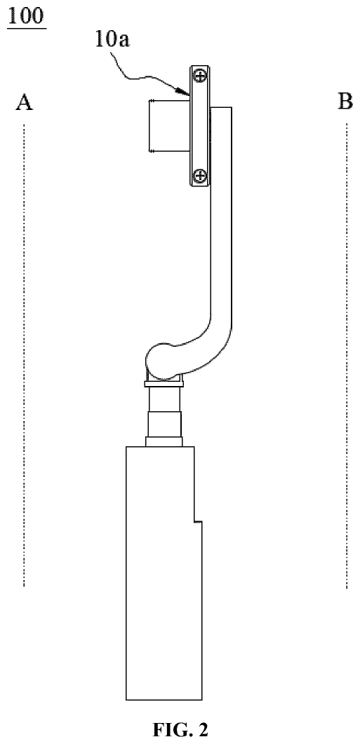

As shown in FIG. 1, the selfie stick 100 includes a clamping assembly 10, an extension and retraction mechanism 20, a handle 30, a shutter button 40, and a supporting member 70. The clamping assembly 10 is configured to clamp the external equipment 200. For convenience of describing an orientation of the selfie stick 100 in this solution, as shown in FIG. 2, a side where the external equipment 200 is located is a first side A. A surface of the clamping assembly 10 that is located on the first side is a main surface 10a. The main surface 10a is configured to abut against the external equipment 200. A side of a surface of the clamping assembly 10 that faces away from the main surface 10a is a second side B. The first side A and the second side B are two opposite orientations of the selfie stick 100. As shown in FIG. 1, the supporting member 70 includes a base 71 and a first connecting part 72 connected to the base 71. One end of the base 71 away from the first connecting part 72 is connected to the clamping assembly 10. The extension and retraction mechanism 20 includes an extendable arm 21 and a second connecting part 22 arranged at one end of the extendable arm 21. The second connecting part 22 is connected to the first connecting part 72. The extendable arm 21 can extend and retract to adjust a length of the selfie stick 100. The handle 30 is connected to one end of the extendable arm 21 away from the second connecting part 22 for a user to hold. A step part 31 is arranged on a surface of the handle 30 located on the second side B. The step part 31 is a protruding structure that protrudes toward the second side B (the handle 30 has an upper end surface close to the second connecting part 22, and a portion that protrudes out of the upper end surface of the handle 30 is defined as the step part 31). The step part 31 includes a first surface 31a for abutting against the index finger of a user. The first surface 31a is at least a portion of a surface of the step part 31 close to the second connecting part 22. The shutter button 40 is arranged on the first surface 31a. The shutter button 40 is operated with the index finger of the user to control the external equipment 200 to take a photo. In this embodiment, when an axis PP′ of the base 71 overlaps or is parallel to an axis PP′ of the handle 30, the main surface 10a and the step part 31 are always located on the two opposite sides of the selfie stick 100. The shutter button 40 is arranged on the first surface 31a of the step part 31, making it convenient for the user to control the external equipment 200 to take a photo with the index finger.

From one side close to the second connecting part 22 to one side away from the second connecting part 22, a distance between at least a portion of the first surface 31a and the axis PP′ of the handle 30 gradually increases. Alternatively, the first surface 31a is perpendicular to the axis PP′ of the handle 30. In this way, when the user presses the shutter button 40 with the index finger, the first surface 31a can provide sufficient support for the index finger of the user to improve the convenience and comfort level of the user in pressing the shutter button 40.

In this embodiment, the first side A and the second side B are the two opposite sides of the selfie stick 100. For ease of understanding, two opposite surfaces of the clamping assembly 10 are used for explanation. It does not mean that the first side A and the second side B only represent the two opposite sides of the clamping assembly 10. The clamping assembly 10 can clamp the external equipment 200 by using a clamping structure, or fix the external equipment 200 by magnetic suction, or fix the external equipment 200 in another way such as clamping. The present invention does not limit this. In this embodiment, the base 71 is a long-strip structure, but certainly, it can also be cylindrical or in another other shape. The axis PP′ of the base 71 is consistent with a length direction of the base. When the selfie stick 100 is in a vertical state, the axis PP′ of the base 71 is parallel to or overlaps an axis PP′ of the extendable arm 21 in a vertical direction. In this embodiment, the first connecting part 72 can be cambered or L-shaped, or can be an extended part of the base 71 in the length direction. The present invention does not limit this. Connection between the first connecting part 72 and the second connecting part 22 can be a fixed connection or a rotatable connection to achieve flipping of the supporting member 70, or another connection. The present invention does not limit this.

For ease of understanding, in the present invention, when a user uses the selfie stick 100, an orientation of one side of the clamping assembly 10 that clamps the external equipment 200 is defined as the first side A, and the other side is defined as the second side B. It can be understood that the first side A and the second side B are two opposite sides of the selfie stick 100, and other components such as the extension and retraction mechanism 20, the handle 30, and the supporting member 70 all have outer surfaces located on the first side A and the second side B. In order to facilitate the operation performed by the user with the index finger and reduce the shaking caused by pressing the shutter button of the existing selfie stick with the thumb or another finger, in the present invention, the shutter button 40 is arranged on the second side B of the handle 30, specifically on the first surface 31a of the step part 31. Furthermore, when the user unfolds the selfie stick 100 for taking a photo, if the axis PP′ of the base 71 overlaps or is parallel to the axis PP′ of the handle 30, the main surface 10a of the clamping assembly 10 and the step part 31 are always located on the two opposite sides regardless of the way of rotation. Namely, the clamping assembly 10 can only implement bending rotation relative to the handle 30, and cannot revolve around the axis PP′ of the extendable arm 21 or the handle 30, so that the shutter button 40 and the main surface 10a of the clamping assembly 10 are always located in directions of facing away from each other. This facilitates the user to quickly control the shutter button with the index finger while holding the handle 30.

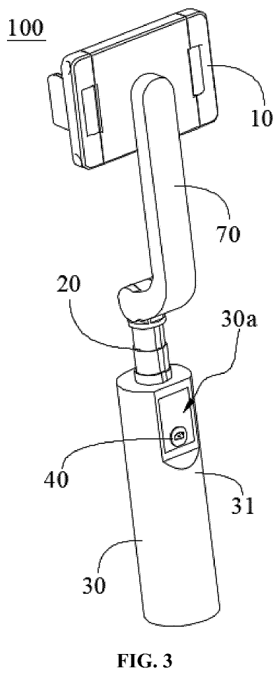

Certainly, as shown in FIG. 3, the handle 30 has a sub surface 30a. The sub surface 30a is a surface of one end of the handle 30 that is located on the second side B and close to the second connecting part 22. The sub surface 30a is connected to the step part 31. The shutter button 40 can also be arranged on the sub surface 30a of the handle 30.

Compared with the prior art, the selfie stick 100 convenient for being operated with the index finger provided in the present invention has the advantages that the step part 31 is arranged on the second side B of the handle 30, and the shutter button 40 is arranged on the first surface 31a of the step part 31 close to the second connecting part 22. In this way, when the user holds the handle 30 in the palm, since the step part 31 is always opposite to the main surface 10a of the clamping assembly 10, the index finger can abut against the step part 31. During use, the user can touch or press the shutter button 40 if the user applies a low force slightly with the index finger, thus taking a photo. Then, the impact on a photo-taking effect caused by shaking of the selfie stick 100 due to a large range of motion of the finger of the user can be avoided, and the user experience can be enhanced.

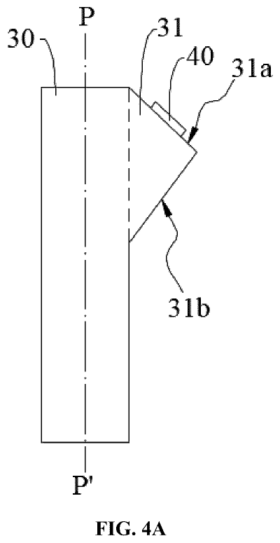

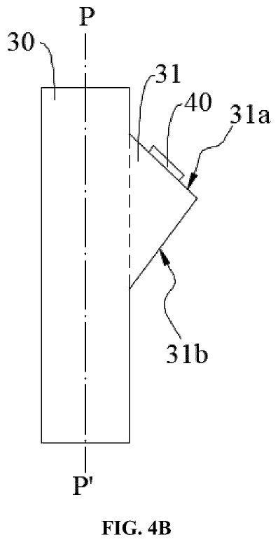

According to the selfie stick 100 shown in FIG. 4A to FIG. 8E, the step part 31 is of the protruding structure on the handle 30. The step part 31 in the present invention only needs to be a structure that can create a height difference with the surface of the handle 30 located on the second side B, to achieve a function of placing and abutting the index finger. It can be understood that the step part 31 has a particular shape structure, which can have one or two or more surfaces, and at least a portion of the surface of the step part 31 close to the second connecting part 22 is defined as the above first surface 31a. The particular shape structure of the step part 31 can include, but is not limited to, the following cases.

As shown in FIGS. 4A and 4B, in a first case, from the side close to the second connecting part 22 to the side away from the second connecting part 22, the distance between the first surface 31a and the axis PP′ of the handle 30 gradually increases. The step part 31 further includes a second surface 31b. The second surface 31b is connected to the first surface 31a and the surface of the handle 30 located on the second side B. From the side close to the second connecting part 22 to the side away from the second connecting part 22, a distance between the second surface 31b and the axis PP′ of the handle 30 gradually decreases. In this case, the step part 31 has two surfaces (i.e. the first surface 31a and the second surface 31b). The first surface 31a can extend from the upper end surface of the handle 30 in a direction away from the second connecting part 22. The first surface 31a can also extend away from the second connecting part 22 after being spaced apart from the upper end surface of the handle 30 by a particular distance. The second surface 31b can extend in the direction away from the second connecting part 22 from a side connected to the first surface 31a until it is connected to a lower end surface of the handle 30. The second surface 31b can also extend in the direction away from the second connecting part 22 from the side connected to the first surface 31a until it is also spaced apart from the lower end surface of the handle 30 by a particular distance.

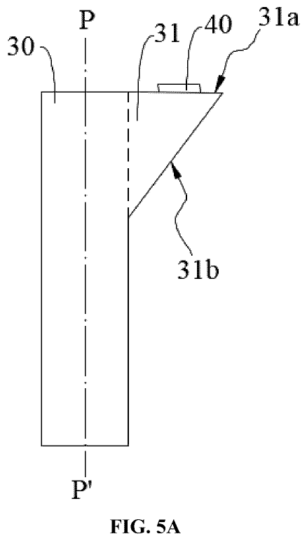

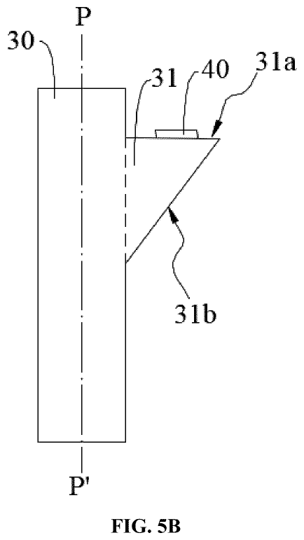

As shown in FIGS. 5A and 5B, in a second case, the first surface 31a is perpendicular to the axis PP′ of the handle 30. The step part 31 further includes a second surface 31b. The second surface 31b is connected to the first surface 31a and the surface of the handle 30 located on the second side B. From one side close to the second connecting part 22 to one side away from the second connecting part 22, a distance between the second surface 31b and the axis PP′ of the handle 30 gradually decreases. In this case, the step part 31 has two surfaces (i.e. the first surface 31a and the second surface 31b). The first surface 31a can extend from the upper end surface of the handle 30 in a direction facing away from the axis PP′ of the handle 30 (i.e. extend outwards in a radial direction of the handle 30). The first surface 31a can also extend in the direction facing away from the axis PP′ of the handle 30 after being spaced apart from the upper end surface of the handle 30 by a particular distance (i.e. extend outwards in the radial direction of the handle 30). The second surface 31b can extend in the direction away from the second connecting part 22 from a side connected to the first surface 31a until it is connected to a lower end surface of the handle 30. The second surface 31b can also extend in the direction away from the second connecting part 22 from the side connected to the first surface 31a until it is also spaced apart from the lower end surface of the handle 30 by a particular distance.

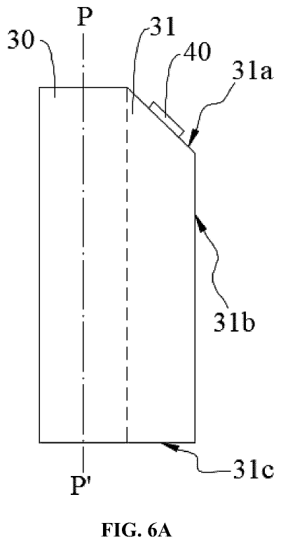

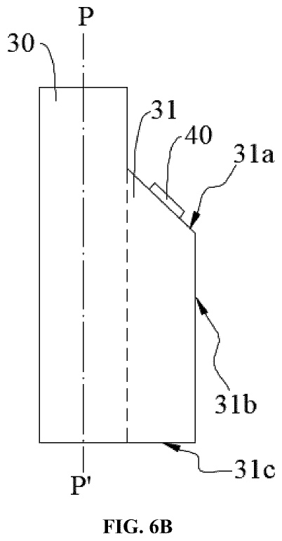

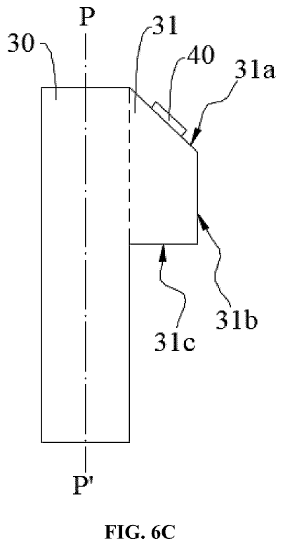

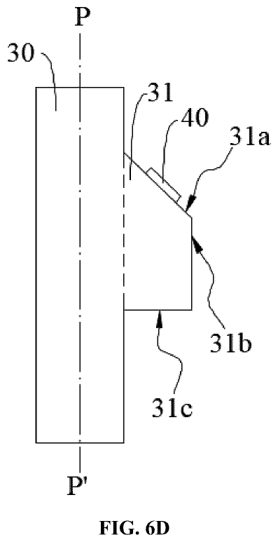

As shown in FIGS. 6A and 6D, in a third case, from the side close to the second connecting part 22 to the side away from the second connecting part 22, the distance between the first surface 31a and the axis PP′ of the handle 30 gradually increase. The step part 31 further includes a second surface 31b and a third surface 31c. The second surface 31b is connected to the first surface 31a. From one side close to the second connecting part 22 to one side away from the second connecting part 22, a distance between the second surface 31b and the axis PP′ of the handle 30 remains unchanged. The third surface 31c is connected to the second surface 31b and the surface of the handle 30 located on the second side B. The third surface 31c is perpendicular to the axis PP′ of the handle 30. In this case, the step part 31 includes three surfaces (i.e. the first surface 31a, the second surface 31b, and the third surface 31c). The first surface 31a can extend from the upper end surface of the handle 30 in a direction away from the second connecting part 22. The first surface 31a can also extend away from the second connecting part 22 after being spaced apart from the upper end surface of the handle 30 by a particular distance. The second surface 31b can extend in the direction away from the second connecting part 22 from a side connected to the first surface 31a until it is connected to a lower end surface of the handle 30. In this case, the third surface 31c is flush with the lower end surface of the handle 30. The second surface 31b can also extend in the direction away from the second connecting part 22 from the side connected to the first surface 31a until it is also spaced apart from the lower end surface of the handle 30 by a particular distance. In this case, the third surface 31c is spaced apart from the lower end surface of the handle 30.

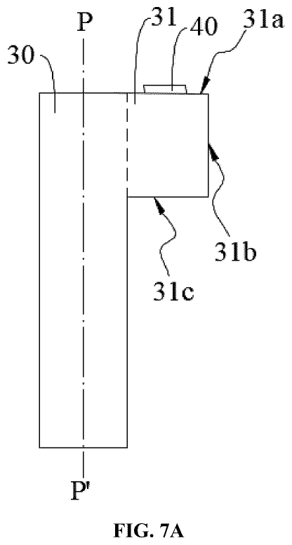

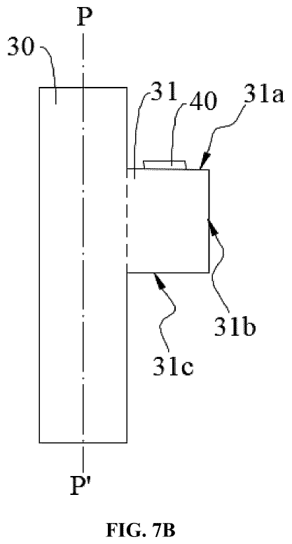

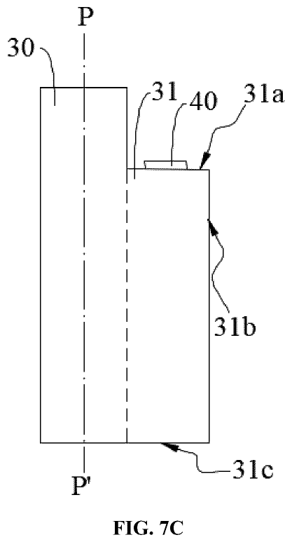

As shown in FIGS. 7A and 7C, in a fourth case, the first surface 31a is perpendicular to the axis PP′ of the handle 30. The step part 31 further includes a second surface 31b and a third surface 31c. The second surface 31b is connected to the first surface 31a. From the side close to the second connecting part 22 to the side away from the second connecting part 22, a distance between the second surface 31b and the axis PP′ of the handle 30 remains unchanged. The third surface 31c is connected to the second surface 31b and the surface of the handle 30 located on the second side B. The third surface 31c is perpendicular to the axis PP′ of the handle 30 (i.e. the third surface 31c is parallel to the first surface 31a). In this case, the step part 31 includes three surfaces (i.e. the first surface 31a, the second surface 31b, and the third surface 31c). The first surface 31a can extend from the upper end surface of the handle 30 in a direction facing away from the axis PP′ of the handle 30 (i.e. extend outwards in a radial direction of the handle 30). The first surface 31a can also extend in the direction facing away from the axis PP′ of the handle 30 after being spaced apart from the upper end surface of the handle 30 by a particular distance (i.e. extend outwards in the radial direction of the handle 30). The second surface 31b can extend in the direction away from the second connecting part 22 from a side connected to the first surface 31a until it is connected to a lower end surface of the handle 30. In this case, the third surface 31c is flush with the lower end surface of the handle 30. The second surface 31b can also extend in the direction away from the second connecting part 22 from the side connected to the first surface 31a until it is also spaced apart from the lower end surface of the handle 30 by a particular distance. In this case, the third surface 31c is spaced apart from the lower end surface of the handle 30.

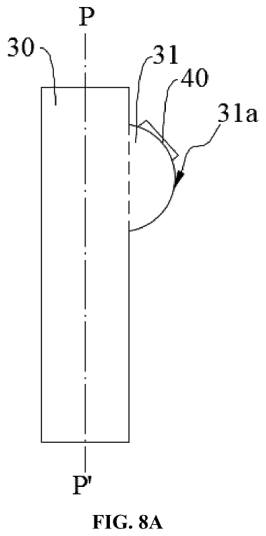

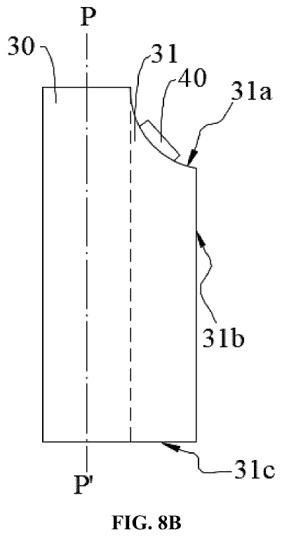

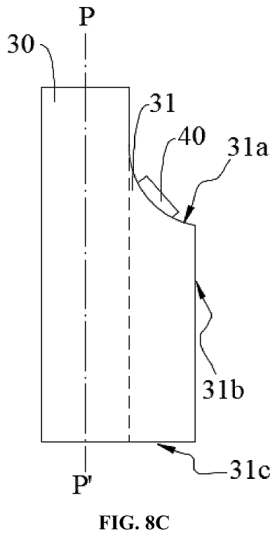

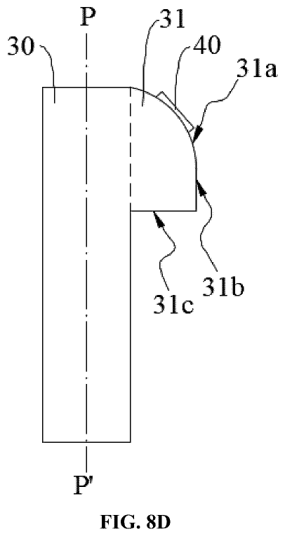

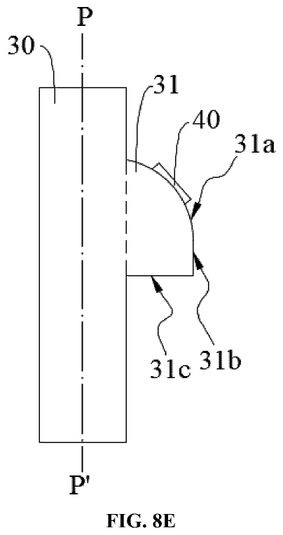

As shown in FIGS. 8A and 8E, in a fifth case, the first surface 31a is a cambered surface bending towards or away from the axis PP′ of the handle 30 (applicable to the case that the step part 31 at least includes the first surface 31a). When the first surface 31a is the cambered surface curved towards the axis PP′ of the handle 30, from the side close to the second connecting part 22 to the side away from the second connecting part 22, the distance between the first surface 31a and the axis PP′ of the handle 30 can gradually increase or can first decrease and then increase. When the first surface 31a is the cambered surface curved away from the axis PP′ of the handle 30, the distance between the first surface 31a and the axis PP′ of the handle 30 can gradually increase or can first increase and then decrease.

It should be noted that the step part 31 can further include another surface such as a fourth surface, a fifth surface, or a sixth surface, which are not limited here. The designer can make a proper design according to actual needs.

It should be noted that when the first surface 31a extends away from the second connecting part 22 after being spaced apart from the upper end surface of the handle 30 by a particular distance, and the second surface 31b extends from the side connected to the first surface 31a in the direction away from the second connecting part 22 until it is spaced apart from the lower end surface of the handle 30 by a particular distance, the arrangement of the step part 31 divides the surface of the handle 30 located on the second side B into two portions, so that the surface of the handle 30 located on the second side B has two surfaces connected to the step part 31. A surface of the handle 30 close to the second connecting part 22 is defined as the above sub surface 30a, namely, the surface of the end of the handle 30 close to the second connecting part 22 and is located on the second side B is the sub surface 30a, and the sub surface 30a is connected to the step part 31. Specifically, in this embodiment of the present invention, the first surface 31a on the step part 31 of the selfie stick 100 can abut against the index finger of the user to provide a supporting role and share a portion of a pressure on the selfie stick 100 and the external equipment 200. Meanwhile, the first surface 31a can also play a role of recognition, making it convenient for the user to feel the step part 31 when the user abuts against the step part 31 with the index finger, thereby locating an approximate position of the shutter button 40 for operation.

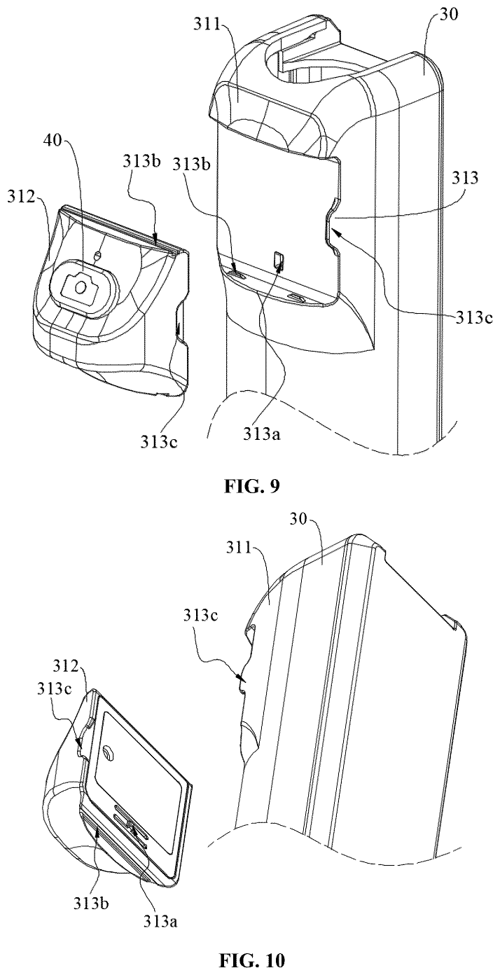

As shown in FIG. 9 and FIG. 10, the shutter button 40 and the handle 30 can be detachably or non-detachably connected to each other.

When the shutter button 40 is detachably connected to the handle 30, the shutter button 40 is detachably mounted on the step part 31, and the step part 31 is non-detachably mounted on the handle 30. The detachable connection may be snap-in connection, magnetic suction connection, screwing, or the like, as long as the shutter button 40 can be removed from the step part 31. The detachable connection separates the shutter button 40 from the step part 31 during use, making it convenient for the user to operate the shutter button within a distance. It is more practical and convenient.

When the shutter button 40 is detachably connected to the handle 30, the step part 31 can also be detachably mounted on the handle 30, and the shutter button 40 is non-detachably mounted on the step part 31. A portion (i.e. a second portion 312 introduced below) of the step part 31 is removable, or the entire step part 31 is removable. The detachable connection may be snap-in connection, magnetic suction connection, screwing, or the like. Specifically, the step part 31 includes a first portion 311 and a second portion 312. The first portion 311 is connected to the handle 30, and the second portion 312 is detachably connected to the first portion 311 through a positioning structure 313. The second portion 312 has the above first surface 31a. The positioning structure 313 includes at least one of a first positioning unit 313a, a second positioning unit 313b, and a third positioning unit 313c that are arranged on the first portion 311 and the second portion 312. The first positioning unit 313a is configured to limit movement of the second portion 312 in a first direction relative to the first portion 311. The second positioning unit 313b is configured to limit movement of the second portion 312 in a second direction relative to the first portion 311. The third positioning unit 313c is configured to limit movement of the second portion 312 in a third direction relative to the first portion 311. The first direction, the second direction, and the third direction are intersected pairwise. The first portion 311 is integrally formed with the handle 30 through injection molding or 3-dimensional (3D) printing. The first positioning unit 313a includes a first convex block and a first groove. The first convex block is arranged on one of the first portion 311 and the second portion 312, and the first groove is provided in the other one of the first portion 311 and the second portion 312. A surface of the first convex block in the first direction abuts against the first groove, thereby limiting the movement of the second portion 312 in the first direction relative to the first portion 311. The second positioning unit 313b includes a second convex block and a second groove. The second convex block is arranged on one of the first portion 311 and the second portion 312, and the second groove is provided in the other one of the first portion 311 and the second portion 312. A surface of the second convex block in the second direction abuts against the second groove, thereby limiting the movement of the second portion 312 relative to the first portion 311 in the second direction. The third positioning unit 313c includes a third convex block and a third groove. The third convex block is arranged on one of the first portion 311 and the second portion 312, and the third groove is provided in the other one of the first portion 311 and the second portion 312. A surface of the third convex block in the third direction abuts against the third groove, thereby limiting the movement of the second portion 312 relative to the first portion 311 in the third direction. Furthermore, the first direction, the second direction, and the third direction are perpendicular pairwise. It should be noted that when the positioning structure 313 includes one of the first positioning unit 313a, the second positioning unit 313b, and the third positioning unit 313c, the first (second/third) convex block and the first (second/third) groove are in clamping fit to achieve relative position fixation between the second portion 312 and the first portion 311. When the positioning structure 313 includes more of the first positioning unit 313a, the second positioning unit 313b, and the third positioning unit 313c, the convex block and groove of at least one of the first positioning unit 313a, the second positioning unit 313b, and the third positioning unit 313c are in clamping fit to achieve relative position fixation between the second portion 312 and the first portion 311. By designing the detachable connection between the second portion 312 and the first portion 311 that carry the shutter button 40, the user can remove the shutter button 40 from the handle 30 for long-distance shooting according to actual needs. Certainly, in other embodiments, the positioning structure 313 may further include a (not shown in the figure) and a threaded hole (not shown in the figure). The threaded hole is provided in the first portion 311, and the screw is threaded through the second portion 312 and is connected to the threaded hole, to achieve relative position fixation between the second portion 312 and the first portion 311. The positioning structure 313 can further include a wedge-shaped block, a spring, and another structure, which will not be limited here.

When the shutter button 40 is detachably connected to the handle 30, the shutter button 40 can be also detachably mounted on the step part 31, and the step part 31 is detachably mounted on the handle 30. Refer to the above detachable connection way, which will not be elaborated here.

When the shutter button 40 is non-detachably connected to the handle 30, the shutter button 40 is non-detachably mounted on the step part 31, and the step part 31 is also non-detachably mounted on the handle 30. Namely, the shutter button 40 is fixedly connected to the step part 31 in an integral molding manner or in another way such as adhesion and laser welding. The present invention does not limit this. By using the non-detachable connection way, the product can be better assembled, thus improving the production and assembling efficiency and reducing the production costs of the product. Meanwhile, it can ensure a firm connection between the step part 31 and the handle 30 of the product.

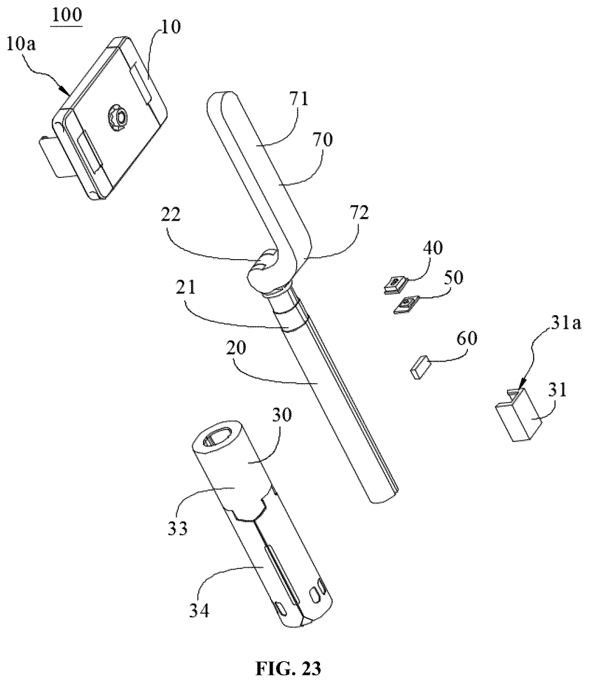

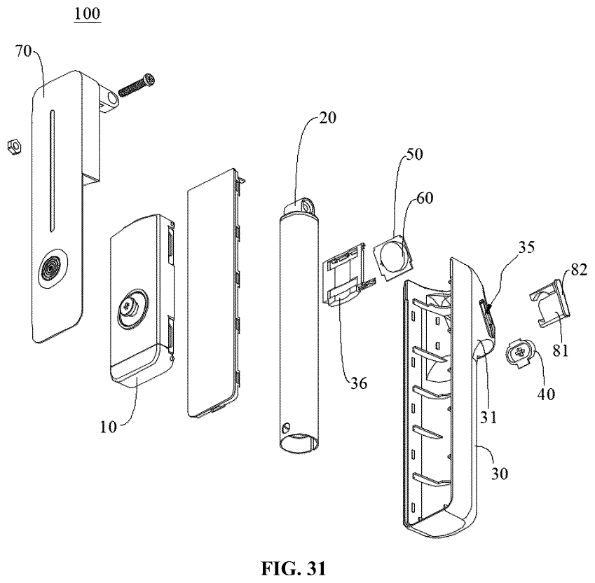

It can be understood that in order to enable the product to better control the external equipment 200 to take a photo, the selfie stick 100 further includes a wireless connection module 50 (not shown in the figure of Embodiment I. For the structure, refer to FIG. 23 of Embodiment III) and a battery module (not shown in the figure of Embodiment I. For the structure, refer to FIG. 23 of Embodiment III) that are arranged in the second portion 312 of the step part 31. The wireless connection module 50 is wirelessly connected to the external equipment 200 and controls the external equipment 200 to take a photo through the shutter button 40. The battery module is electrically connected to the wireless connection module 50 to supply power to the wireless connection module 50. In this embodiment, a Bluetooth module is taken as an example. The external equipment 200 is connected and controlled to take a photo through the shutter button 40. Certainly, in other embodiments, the external equipment 200 can be connected and controlled in other wireless connection manners. The present invention does not limit this. In order to reduce the volume of the product, a battery 60 in the battery module in this embodiment is a button cell. Certainly, in other embodiments, the battery can be a rechargeable battery or a dry battery. The present invention does not limit this. In this embodiment, the shutter button 40 can be a mechanical button or a touch button, as long as it can control the external equipment 200 to take a photo after being touched and pressed. By the arrangement of the wireless connection module 50 and the battery module, it is possible to wirelessly connect the external equipment 200 to take a video and improve the portability of the product, without laying wires in the product, which effectively reduces the product costs. Certainly, in some other embodiments, the selfie stick 100 further includes a circuit board (not shown in the figure), and the wireless connection module 50 and the like are all arranged on the circuit board. The selfie stick 100 can be also integrated with other functions. Specifically, the battery module includes a mounting component 80 and a battery 60 that are detachably mounted on the second portion 312. The second portion 312 of the step part 31 is provided with a mounting port 35 (not shown in the figure of Embodiment I. For the structure, refer to FIG. 31 of Embodiment IV). More specifically, the mounting port 35 is provided in a side surface of the second portion 312 of the step part 31, and the mounting component 80 is arranged inside an inner cavity of the second portion 312 of the step part 31. The mounting component 80 includes a mounting plate 81 (not shown in the figure of Embodiment I. For the structure, refer to FIG. 31 of Embodiment IV) for mounting the battery 60, and a cover plate 82 (not shown in the figure of Embodiment I. For the structure, refer to FIG. 31 of Embodiment IV) connected to the mounting plate 81. The cover plate 82 is arranged at the mounting port 35 to achieve sealing. In order to facilitate removal of the mounting component 80, a bevel notch is further arranged at the mounting port 35, which is convenient for removal.

It should be noted that in the present invention, a maximum size of the selfie stick 100 in a folded storage state in an extension and retraction direction of the extendable arm 21 is greater than or equal to 10 cm and less than or equal to 15 cm. Preferably, the maximum size is greater than or equal to 11.3 cm and less than or equal to 13 cm. For example, the maximum size of the selfie stick 100 in the folded storage state in the extension and retraction direction of the extendable arm 21 can be, but is not limited to, 11.3 cm, 11.8 cm, 12.3 cm, 12.8 cm, 13.0 cm, or the like. In this embodiment, the maximum size of the selfie stick 100 in the folded storage state in the extension and retraction direction of the extendable arm 21 is 12 cm.

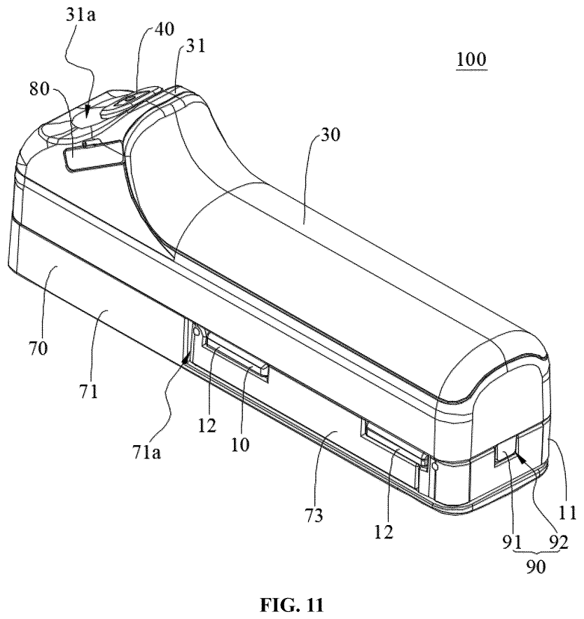

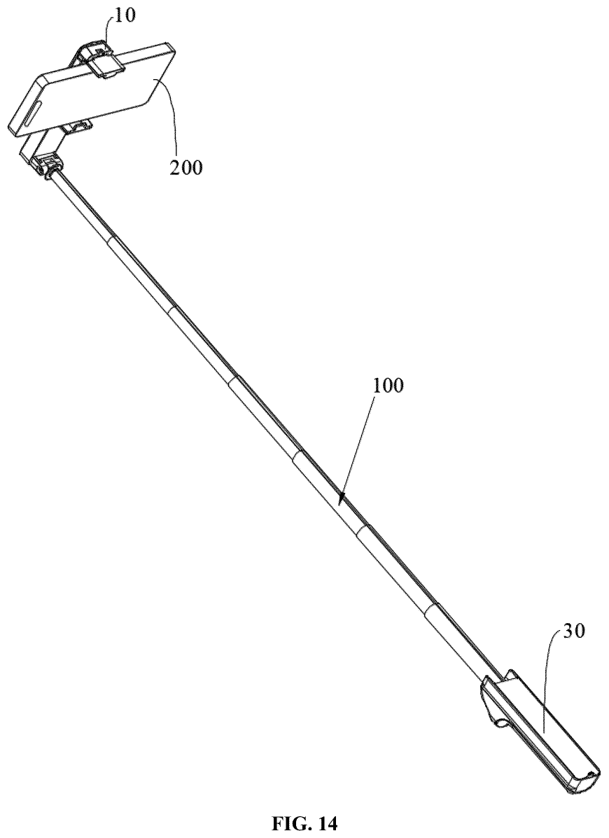

As shown in FIG. 11 to FIG. 14, a second embodiment of the present invention provides a selfie stick 100 convenient for being operated with an index finger. It can be understood that the design of a specific shape of a step part 31 of the selfie stick 100 in the second embodiment is the same as that of the step part 31 of the selfie stick 100 in the first embodiment, and will not be elaborated here. The following will introduce structures, which are different from those structures in the selfie stick 100 in the first embodiment, of the selfie stick 100 in the second embodiment.

As shown in FIG. 11, the supporting member 70 and the clamping assembly 10 form a connecting mechanism. The first connecting part 72 is rotatably connected to the second connecting part 22, so that when the extendable arm 21 is in a retracted state and is located in the handle 30, the connecting mechanism and the handle 30 can switch between an unfolded use state and a folded storage state. An end of the connecting mechanism close to the first connecting part 72 and the second connecting part 22 and an end of the handle 30 close to the first connecting part 72 and the second connecting part 22 are first ends of the connecting mechanism and the handle 30. An end of the connecting mechanism away from the first connecting part 72 and the second connecting part 22 and an end of the handle 30 away from the first connecting part 72 and the second connecting part 22 are second ends of the connecting mechanism and the handle 30. The first ends and the second ends are opposite to each other. The selfie stick 100 further includes a locking assembly 90. The locking assembly 90 includes a shackle 91 and a locking notch 92. The shackle 91 is arranged at one of the second end of the connecting mechanism and the second end of the handle 30. The locking notch 92 is provided in the other one of the second end of the connecting mechanism and the second end of the handle 30. When the connecting mechanism and the handle 30 are in the storage state, the shackle 91 is connected to the locking notch 92 to lock the connecting mechanism to the handle 30.

As shown in FIG. 11 to FIG. 14, the selfie stick 100 includes the handle 30, the connecting mechanism, and the locking assembly 90.

The handle 30 is used as a handle of the selfie stick 100 and is configured to be held by a user. The specific shape of the handle 30 is not limited. The designer can make a proper design according to actual needs. For example, a cross section of the handle 30 in a direction perpendicular to a central axis PP′ of the handle 30 can be, but is not limited to, rectangular or semicircular. There is no limitation on a specific material of the handle 30. The designer can make a proper choice according to actual needs. For example, a material of the handle 30 can be, but is not limited to, plastic or rubber.

The connecting mechanism is used as a connecting structure of the selfie stick 100 and is configured to mount external equipment 200 to support the external equipment 200. The connecting mechanism includes the above clamping assembly 10 and the above supporting member 70. A specific structure of the connecting mechanism will be introduced below.

The connecting mechanism and the handle 30 are rotatably connected to each other through a first connecting part 72 and a second connecting part 22, so that an opening angle between the connecting mechanism and the handle 30 can be adjusted. There is no limitation on a way of the rotational connection between the connecting mechanism and the handle 30 here. The designer can make a proper design according to actual needs. It should be noted that the connecting mechanism and the handle 30 can be rotatably connected in a damping manner, to achieve multi-angle stable rotation and supporting between the connecting mechanism and the handle 30.

An end of the connecting mechanism close to the first connecting part 72 and the second connecting part 22 and an end of the handle 30 close to the first connecting part 72 and the second connecting part 22 are first ends of the connecting mechanism and the handle 30. An end of the connecting mechanism away from the first connecting part 72 and the second connecting part 22 and an end of the handle 30 away from the first connecting part 72 and the second connecting part 22 are second ends of the connecting mechanism and the handle 30. The first ends and the second ends are opposite to each other.

The connecting mechanism and the handle 30 can switch between an unfolded use state and a folded storage state. The connecting mechanism and the handle 30 are rotated to be unfolded in a manner of facing away from each other, to achieve the use state. In this case, the second end of the connecting mechanism and the second end of the handle 30 move away from each other. The connecting mechanism and the handle 30 are rotated towards each other to be folded, to achieve the storage state. In this case, the second end of the connecting mechanism and the second end of the handle 30 move close to each other. In this way, when a user needs to take a photo with the selfie stick 100, the user rotates the connecting mechanism and the handle 30 to be unfolded in the manner of facing away from each other and then mounts the external equipment 200 on the connecting mechanism, to facilitate a photo-taking operation. On the contrary, when the user does not need to take a photo with the selfie stick 100, the user rotates the connecting mechanism and the handle 30 towards each other to be folded, to facilitate storage.

The locking assembly 90 is used as a locking and unlocking structure of the selfie stick 100 to lock the connecting mechanism to the handle 30 when the connecting mechanism and the handle 30 are in the above storage state, so as to achieve relative position fixation between the connecting mechanism and the handle 30.

The locking assembly 90 includes a shackle 91 and a locking notch 92. The shackle 91 is arranged at one of the second end of the connecting mechanism and the second end of the handle 30. The locking notch 92 is provided in the other one of the second end of the connecting mechanism and the second end of the handle 30. For example, the shackle 91 can be arranged at the second end of the handle 30, and the locking notch 92 can be provided in the second end of the connecting mechanism. Alternatively, the locking notch 92 is provided in the second end of the handle 30, and the shackle 91 is arranged at the second end of the connecting mechanism. By designing the shackle 91 and the locking notch 92, when the connecting mechanism and handle 30 are in the folded storage state, the shackle 91 and the locking notch 92 are in snap-in connection, to achieve relative position fixation between the connecting mechanism and the handle 30. The structure is simple and is easy to implement.

It can be understood that the first end of the connecting mechanism is rotatably connected to the first end of the handle 30, and the second end of the connecting mechanism is connected to the second end of the handle 30 through the shackle 91 and the locking notch 92. Since the first ends and the second ends are away from and opposite to each other, this end portion connection can effectively prevent unnecessary vibration between the connecting mechanism and the handle 30 caused by an external force (especially for a long-strip object), thus improving the stability of the overall structure of the selfie stick 100 in the storage state. Through the end portion connection, the connecting mechanism and the handle 30 (especially for a long-strip object) can better bear bending and twisting moments, thus improving the overall rigidity of the selfie stick 100 in the storage state.

Based on the selfie stick 100 convenient for being operated with the index finger in this embodiment of the present invention, the second end of the connecting mechanism and the second end of the handle 30 are connected by the shackle 91 and the locking notch 92, so that relative position fixation between the connecting mechanism and the handle 30 can be achieved when the connecting mechanism and the handle 30 are in the folded storage state. The connecting mechanism and the handle 30 cannot be opened freely, to facilitate storage. By designing the rotatable connection between the first end of the connecting mechanism and the first end of the handle 30, and connecting the second end of the connecting mechanism to the second end of the handle 30 through the shackle 91 and the locking notch 92, the end portion connection between the connecting mechanism and the handle 30 at the opposite first and second ends can be achieved, which effectively prevents the end portions of the connecting mechanism and the end portions of the handle 30 from upwarping.

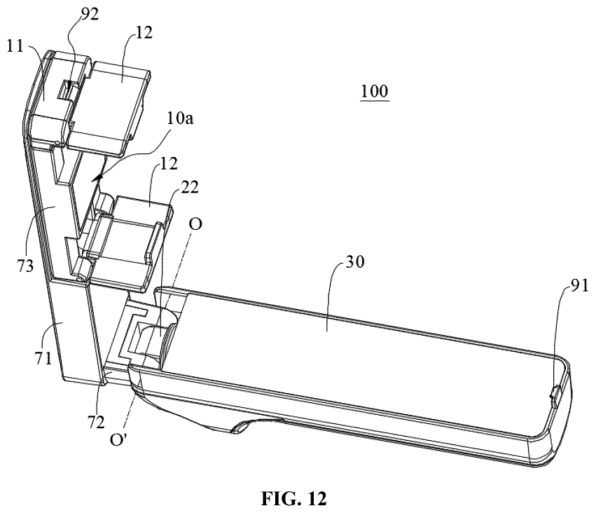

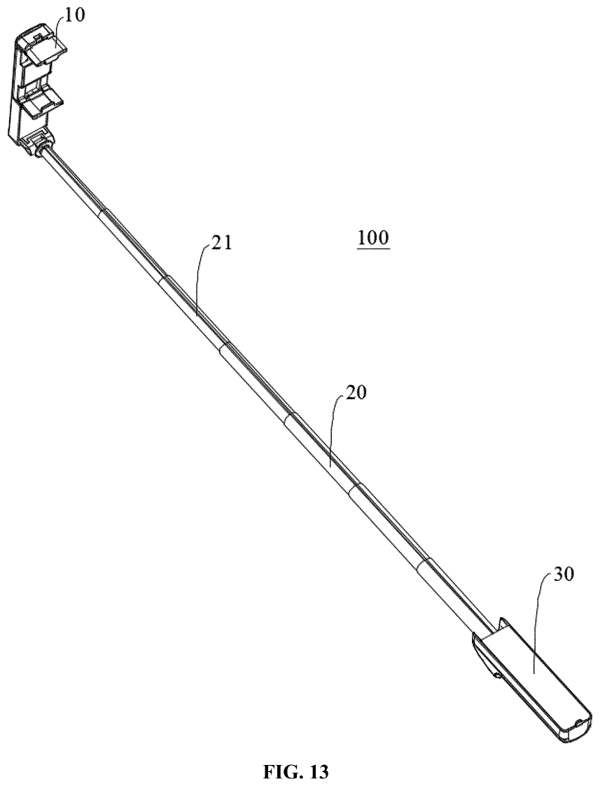

As shown in FIG. 11 to FIG. 12, the shackle 91 is located in a middle position of the second end of the handle 30, and the locking notch 92 is provided in a middle position of the second end of the connecting mechanism. In this way, when the connecting mechanism and the handle 30 are in the folded storage state, connection positions of both the connecting mechanism and the handle 30 are in the middle, so that the force applied thereto is relatively uniform, and it is not likely to cause single-side upwarp.

As shown in FIG. 11 to FIG. 12, the supporting member 70 further includes a rotating member 73. The clamping assembly 10 includes an extension and retraction member 11 and two clamping members 12. The base 71 is rotatably connected to the handle 30. A mounting space 71a is formed in the base 71. The rotating member 73 is located in the mounting space 71a and is rotatably connected to the base 71. The extension and retraction member 11 is located at an end portion of the rotating member 73 and can perform extension and retraction motion relative to the rotating member 73. One clamping member 12 is connected to the rotating member 73, and the other clamping member 12 is connected to the extension and retraction member 11. The two clamping members 12 can clamp and fix the external equipment 200 from two sides of the external equipment 200.

The base 71 is used as a seat of the supporting member 70 to provide a stable supporting platform. There is no limitation on a specific material of the base 71. The designer can make a proper choice according to actual needs. For example, a material of the base 71 can be, but is not limited to, plastic or rubber. The mounting space 71 is a region on the base 71 to accommodate the rotating member 73.

The rotating member 73 is used as a rotating body of the supporting member 70. An angle of the external equipment 200 supported on the supporting member is adjusted through rotation, to enhance the convenience of use of the selfie stick 100. There is no limitation on a specific structure of the rotating member 73. The designer can make a proper design according to actual needs. For example, the rotating member 73 can be, but is not limited to, a plate-like structure or a framework structure. It should be noted that a damping rotatable connection can be used between the rotating member 73 and the base 71, to achieve multi-angle stable rotation and supporting between the rotating member 73 and the base 71.

The extension and retraction member 11 is used as an adjusting member for the clamping assembly 10, to adjust a spacing between the two clamping members 12 by performing the extension and retraction motion, so that the two clamping members 12 can clamp and fix external equipment 200 with different sizes. There is no limitation on a specific structure of the extension and retraction member 11. The designer can make a proper design according to actual needs. For example, the extension and retraction member 11 can be, but is not limited to, a plate-like structure or a blocky structure. Since the clamping assembly 10 is not the focus of the present invention, a specific way of the connection between the extension and retraction member 11 and the rotating member 73 will not be elaborated here.

The clamping assembly 12 is used as a fixing member 36 of the clamping assembly 10 to clamp and fix the external equipment 200 from two sides of the external equipment 200. There is no limitation on a specific structure of each clamping member 12. The designer can make a proper design according to actual needs. For example, the clamping member 12 can be, but is not limited to, a clip structure or a plate-like structure. Since the clamping assembly 10 is not the focus of the present invention, a specific way of the connection between the clamping members 12 and the rotating member 73 and a specific way of the connection between the clamping members 12 and the extension and retraction member 11 will not be elaborated here. It should be noted that when there are two extension and retraction members 11, which can be respectively located at the two end portions of the rotating member 73 (i.e. one-to-one correspondence). In this case, the two clamping members 12 are connected to the two extension and retraction members 11 in a one-to-one correspondence manner.

A specific way for setting the shackle 91 (or the locking notch 92) on the connecting mechanism can include, but is not limited to, the following cases.

As shown in FIG. 11 to FIG. 12, in one case, one end of the extension and retraction member 11 away from the rotating member 73 is used as the second end of the connecting mechanism, and one of the shackle 91 and the locking notch 92 is arranged on the extension and retraction member 11. In this way, when the connecting mechanism and the handle 30 are in the folded storage state, the shackle 91 (or locking notch 92) is directly connected to the locking notch 92 (or shackle 91) arranged on the extension and retraction member 11, which can achieve relative position fixation between the connecting mechanism and the handle 30. The operation is simple. This facilitates storage.

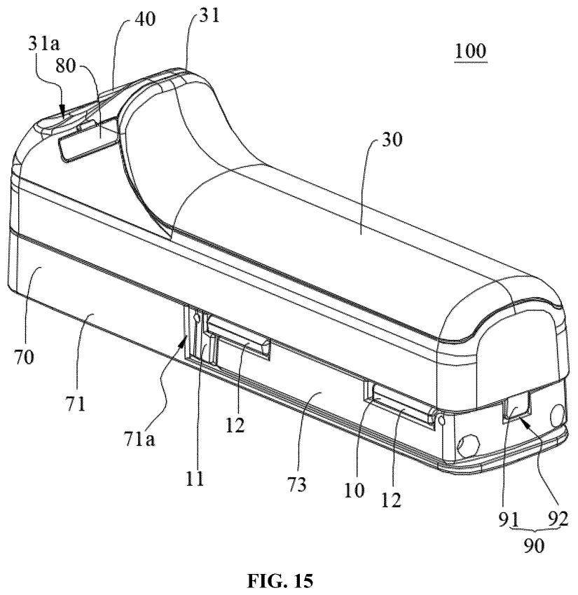

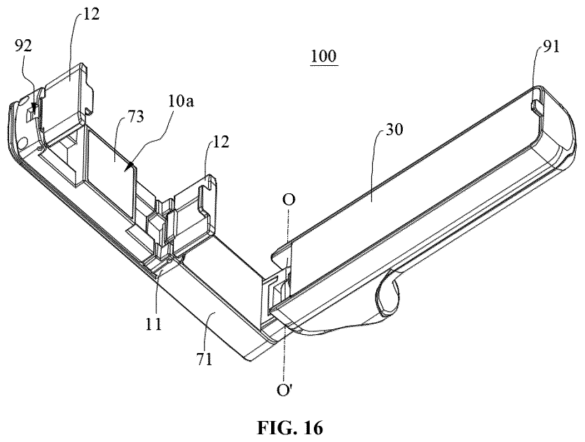

As shown in FIG. 15 to FIG. 16, in a second case, one end of the rotating member 73 away from the extension and retraction member 11 is used as the second end of the connecting mechanism, and one of the shackle 91 and the locking notch 92 is arranged on the rotating member 73. In this way, when the connecting mechanism and the handle 30 are in the folded storage state, the shackle 91 (or locking notch 92) is directly connected to the locking notch 92 (or shackle 91) arranged on the rotating member 73, which can achieve relative position fixation between the connecting mechanism and the handle 30. The operation is simple. This facilitates storage.

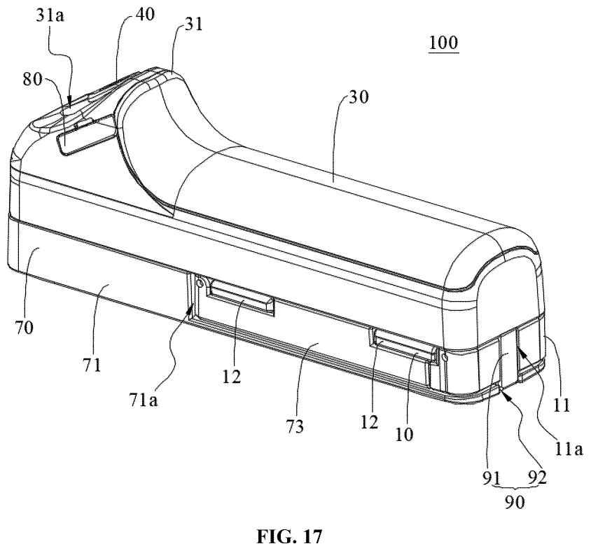

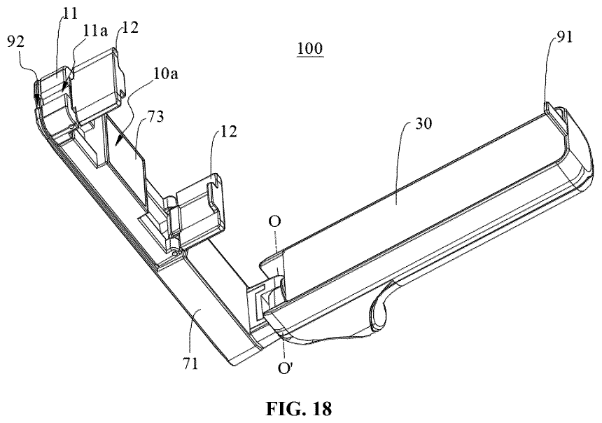

As shown in FIG. 17 to FIG. 18, in a third case, one end of the base 71 away from a rotation center OO′ (i.e. a rotation axis PP′ of the first connecting part 72 and the second connecting part 22) is used as the second end of the connecting mechanism, and one of the shackle 91 and the locking notch 92 is arranged on the base 71. In this way, when the connecting mechanism and the handle 30 are in the folded storage state, the shackle 91 (or locking notch 92) is directly connected to the locking notch 92 (or shackle 91) arranged on the base 71, which can achieve relative position fixation between the connecting mechanism and the handle 30. The operation is simple. This facilitates storage.

Specifically, an avoidance slot 11a is provided in one end of the extension and retraction member 11 away from the rotating member 73. When the shackle 91 and the locking notch 92 are in snap-in connection, the shackle 91 is arranged in the avoidance slot 11a. By designing the avoidance slot 11a in one end of the extension and retraction member 11 away from the rotating member 73, when the shackle 91 and the locking notch 92 are in snap-in connection, the shackle 91 is arranged in the avoidance slot 11a, which achieves dual fixation on the shackle 91. In this way, the stability of connection between the connecting mechanism and the handle 30 in the storage state can be effectively improved.

It should be noted that in other cases, the end of the extension and retraction member 11 away from the rotating member 73 can be used as the second end of the connecting mechanism, and the end of the rotating member 73 away from the extension and retraction member 11 can also be used as the second end of the connecting mechanism. When the rotating member 73 rotates to cause the extension and retraction member 11 farther away from the rotation center OO′ relative to the rotating member 73, the shackle 91 (or locking notch 92) can be connected to the locking notch 92 (or shackle 91) arranged on the extension and retraction member 11. On the contrary, when the rotating member 73 rotates to cause the rotating member 73 farther away from the rotation center OO′ relative to the extension and retraction member 11, the shackle 91 (or locking notch 92) can be connected to the locking notch 92 (or shackle 91) arranged on the rotating member 73. In this way, the convenience of storage of the selfie stick 100 can be further improved.

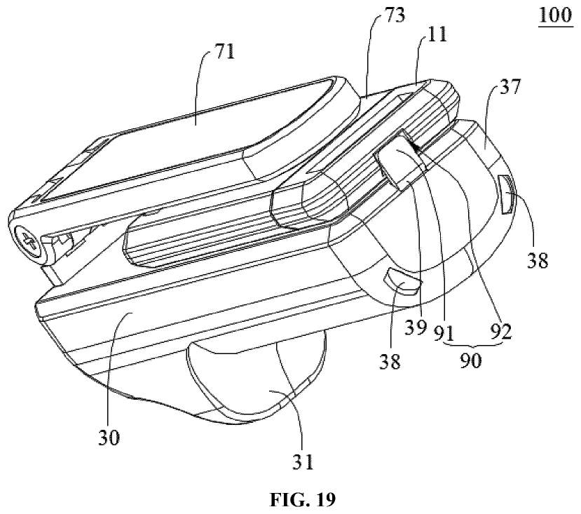

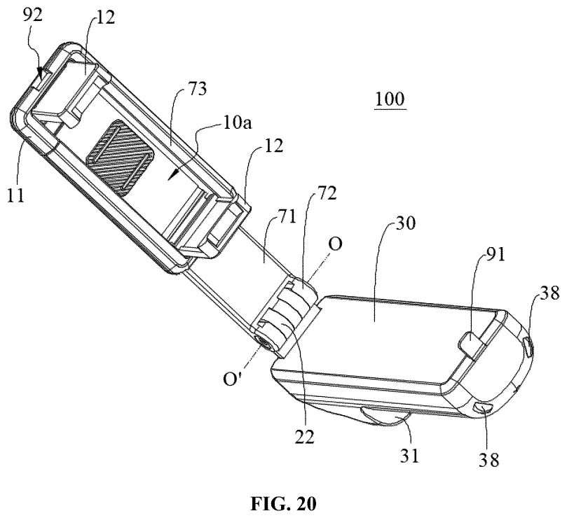

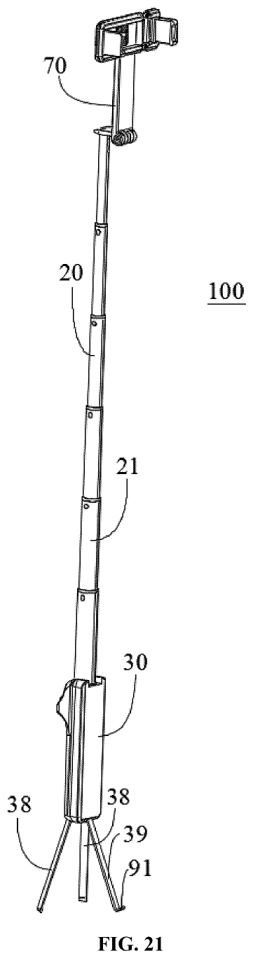

Certainly, as shown in FIG. 19 to FIG. 21, the handle 30 includes a shell 37, a first supporting leg 38, and a second supporting leg 39. The shell 37 is rotatably connected to the connecting mechanism (the shell 37 is indirectly rotatably connected to the first connecting part 72 of the supporting member 70 through the second connecting part 22 of the extension and retraction mechanism 20), and the shell 37 has an accommodating cavity (not shown in the figure). The first supporting leg 38 is movably connected to the shell 37. The second supporting leg 39 is used as the second end of the handle 30 and is movably connected to the shell 37. One of the shackle 91 and the locking notch 92 is arranged on the second supporting leg 39. The first supporting leg 38 and the second supporting leg 39 have a first state of extending out of the accommodating cavity. The first supporting leg 38 and the second supporting leg 39 further have a second state of being stored inside the accommodating cavity. The first supporting leg 38 and the second supporting leg 39 can switch between the first state and the second state. It should be noted that in the first state, the first supporting leg 38 and the second supporting leg 39 cooperate with each other to be in contact with a surface to be touched (which can be a ground or a tabletop). In the second state (and when the connecting mechanism and handle 30 are in the above storage state), the second supporting leg 39 is connected to the connecting mechanism through the shackle 91 and the locking notch 92. A specific way of the movable connection between the first supporting leg 38 (second supporting leg 39) and the shell 37 is not limited here. The designer can make a reasonable design according to actual needs, as long as the first supporting leg 38 (second supporting leg 39) has the first state of extending out of the accommodating cavity of the shell 37 and the second state of being stored inside the accommodating cavity of the shell 37. When the first supporting leg 38 and the second supporting leg 39 are in the first state of extending out of the accommodating cavity of the shell 37, the first supporting leg 38 and the second supporting leg 39 cooperate with each other to form a stable supporting structure to be in contact with the surface to be touched. In this case, a user can release the two hands and directly place the selfie stick 100 on the surface to be touched to take a photo. Furthermore, the first supporting leg 38 and the second supporting leg 39 make proper use of an internal region (i.e. the accommodating cavity) of the shell 37, so that when the selfie stick 100 is idle, both the first supporting leg 38 and the second supporting leg 39 can be stored into the accommodating cavity of the shell 37, which can reduce a space occupancy rate of the selfie stick 100. It is worth mentioning that the second supporting leg 39 can not only cooperate with the first supporting leg 38 to form the stable supporting mechanism to be in contact with the surface to be touched, but also cooperate with the shackle 91 (or locking notch 92) to be connected to the locking notch 92 (or shackle 91), so that relative position fixation between the connecting mechanism and the handle 30 can be achieved when the connecting mechanism and the handle 30 are in the folded storage state, and the connecting mechanism and the handle 30 cannot be opened freely, which facilitates storage.

The selfie stick 100 further includes a wireless connection module 50 (not shown in the figure of Embodiment II. For the structure, refer to FIG. 31 of Embodiment IV) and a battery module (not shown in the figure of Embodiment II. For the structure, refer to FIG. 31 of Embodiment IV). The shutter button 40 is connected to the wireless connection module 50. The battery module is electrically connected to the wireless connection module 50 to supply power to the wireless connection module 50. A battery 60 in the battery module in this embodiment uses a button cell. For ease of battery replacement, in this embodiment, the battery module is detachably mounted on the step part 31. The battery module includes a mounting component 80 detachably mounted on the step part 31 and the battery 60. The step part 31 is provided with a mounting port 35 (not shown in the figure of Embodiment II. For the structure, refer to FIG. 31 of Embodiment IV). Specifically, the mounting port 35 is provided in a side surface of the step part 31, and the mounting component 80 is arranged inside an inner cavity of the step part 31. The mounting component 80 includes a mounting plate 81 (not shown in the figure of Embodiment II. For the structure, refer to FIG. 31 of Embodiment IV) for mounting the battery 60, and a cover plate 82 (not shown in the figure of Embodiment II. For the structure, refer to FIG. 31 of Embodiment IV) connected to the mounting plate 81. The cover plate 82 is arranged at the mounting port 35 to achieve sealing. In order to facilitate removal of the mounting component 80, a bevel notch is further arranged at the mounting port 35, which is convenient for removal.

It should be noted that in the second embodiment, the step part 31 is specifically arranged on the shell 37 of the handle 30. For a specific way of the arrangement of the step part 31 on the shell 37 of the handle 30 and a specific shape of the step part 31, refer to the first embodiment. They will not be elaborated here. Of course, referring to the first embodiment described above, the step part 31 includes a first portion 311 connected to the shell 37 of the handle 30, and a second portion 312 detachably connected to the first portion 311. The shutter button 40, the wireless connection module 50, and the battery module are all arranged at the second portion 312, and the battery module is detachably mounted at the second portion 312. This will not be elaborated here.

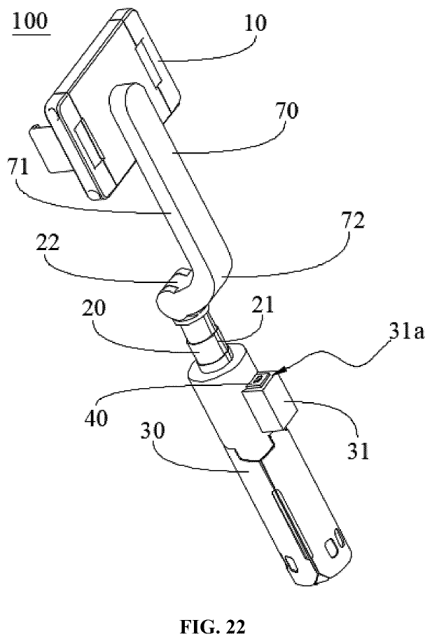

As shown in FIG. 22, a third embodiment of the present invention provides a selfie stick 100 convenient for being operated with an index finger. It can be understood that the design of a specific shape of a step part 31 of the selfie stick 100 in the third embodiment is the same as that of the step part 31 of the selfie stick 100 in the first embodiment, and will not be elaborated here. The following will introduce structures, which are different from those structures in the selfie stick 100 in the first embodiment, of the selfie stick 100 in the third embodiment.

The handle 30 includes a third connecting part 33 and three supporting legs 34 capable of achieving separable supporting. One end of each of the three supporting legs 34 is rotatably connected to the third connecting part 33.

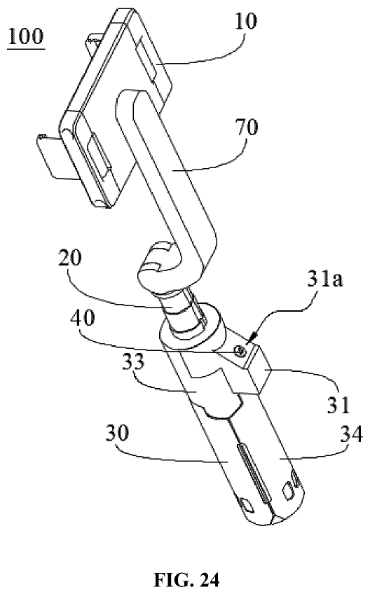

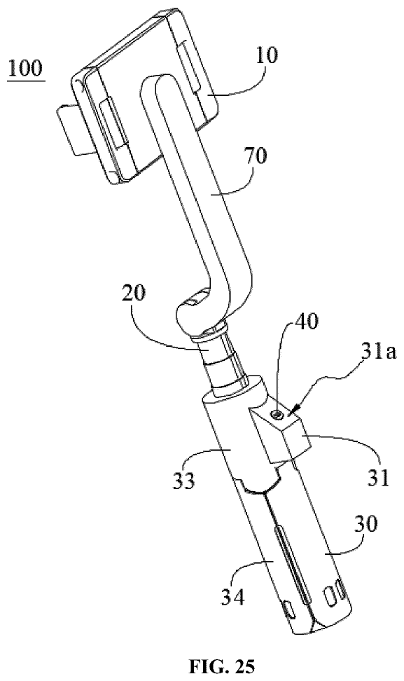

Specifically, as shown in FIG. 22 to FIG. 25, the step part 31 is arranged on the supporting leg 34 located on the second side B. It can be understood that the three supporting legs 34 can form a stable supporting structure, namely a tripod, which can stably support the selfie stick 100 to take a photo after being opened, thereby improving the stability during photo taking and avoiding the occurrence of shaking during photo taking. The structure of the tripod is a mature conventional design and will not be further elaborated in the present invention. Since the step part 31 has various different shapes (specifically referring to FIG. 4A to FIG. 8E), there are also various different design methods for arranging the step part 31 on the supporting leg 34. FIG. 22 and FIG. 25 show various cases in which the step part 31 is arranged on the supporting leg 34. The specific shape of the step part 31 will not be further elaborated in this embodiment. By the arrangement of the supporting legs 34, the handle 30 can stand stably on an object surface such as a tabletop or a ground, thus avoiding shaking and improving the stability during photo taking. Meanwhile, the shutter button 40 is arranged on the supporting leg 34 on a back surface of the handle 30, which makes it convenient for a user to use operate the shutter button 40 to take a photo with the index finger, thus improving the convenience of the photo-taking operation.

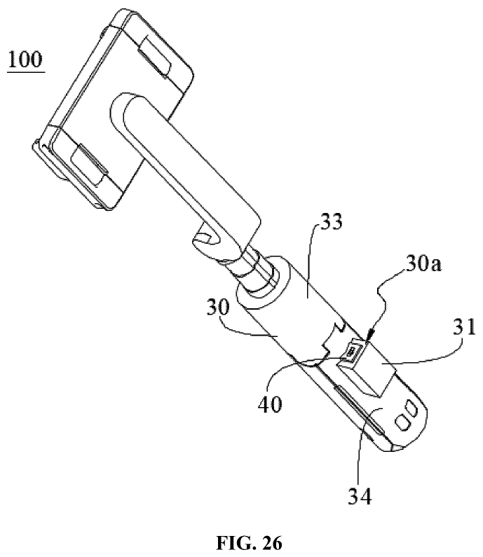

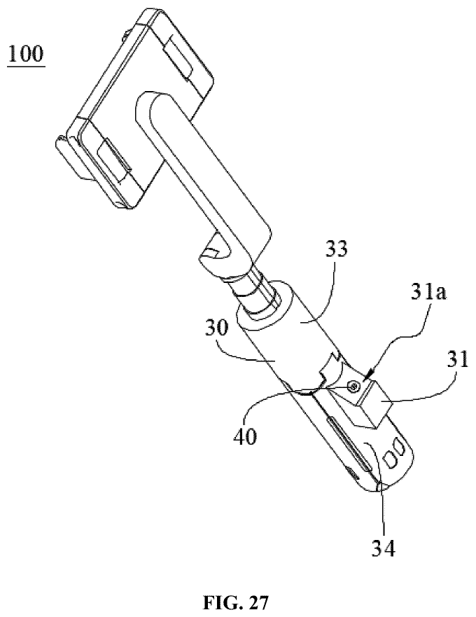

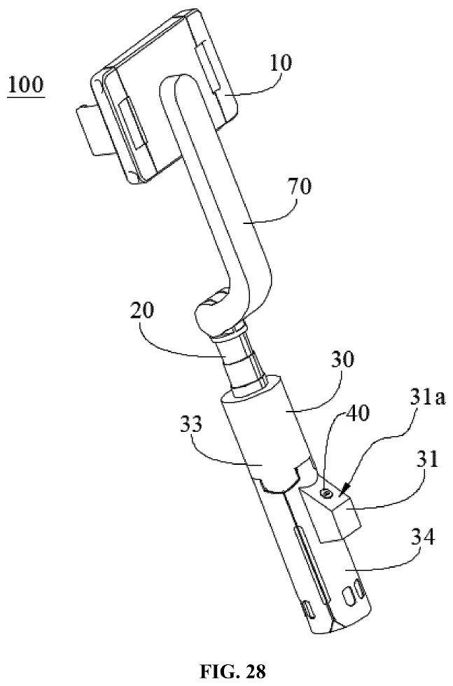

Specifically, as shown in FIG. 26 to FIG. 28, the step part 31 is arranged on the third connecting part 33. It can be understood that the three supporting legs 34 can form a stable supporting structure, namely a tripod, which can stably support the selfie stick 100 to take a photo after being opened, thereby improving the stability during photo taking and avoiding the occurrence of shaking during photo taking. The structure of the tripod is a mature conventional design and will not be further elaborated in the present invention. Since the step part 31 has various different shapes (specifically referring to FIG. 4A to FIG. 8E), there are also various different design methods for arranging the step part 31 on the third connecting part 33. FIG. 26 and FIG. 28 show various cases in which the step part 31 is arranged on the third connecting part 33. The specific shape of the step part 31 will not be further elaborated in this embodiment. The shutter button 40 is arranged on the third connecting part 33, which is convenient for a user to operate the shutter button 40 to take a photo with the index finger, thus improving the convenience of the photo-taking operation.

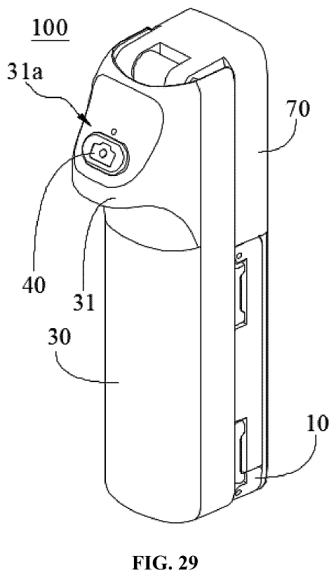

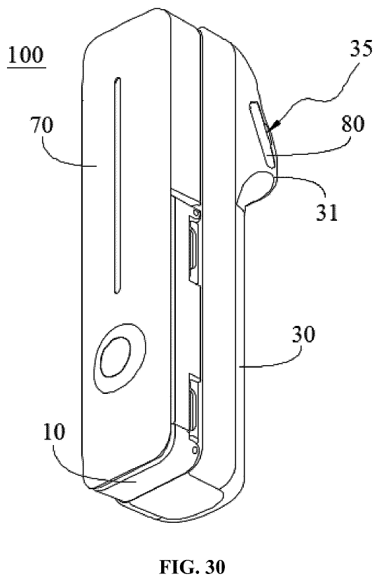

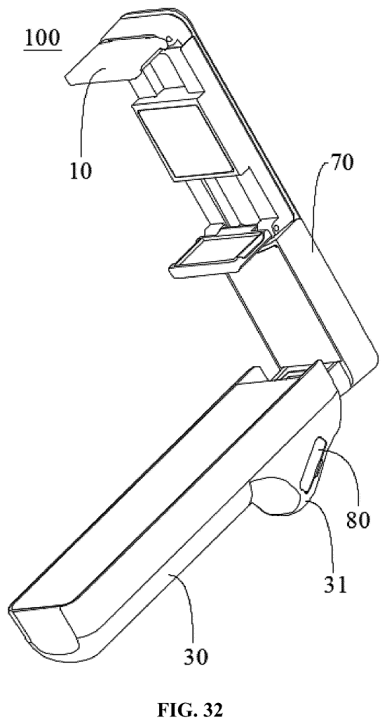

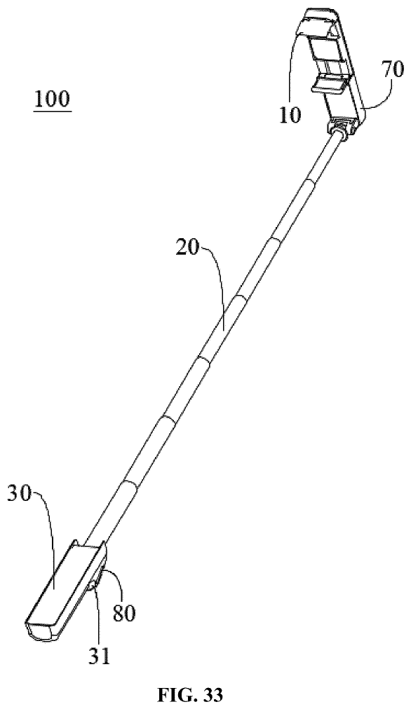

As shown in FIG. 29 to FIG. 33, a fourth embodiment of the present invention provides a selfie stick 100 convenient for being operated with an index finger. It can be understood that the design of a specific shape of a step part 31 of the selfie stick 100 in the fourth embodiment is the same as that of the step part 31 of the selfie stick 100 in the first embodiment, and will not be elaborated here.

The selfie stick 100 includes a clamping assembly 10, an extension and retraction mechanism 20, a handle 30, a shutter button 40, a wireless connection module 50, a battery module, and a supporting member 70. The step part 31 is arranged on one side of the handle 30 close to one end. Specifically, in this embodiment, the step part 31 is arranged at one end of the handle 30 close to the clamping assembly 10. The step part 31 has a first surface 31a close to the second connecting part 22. The first surface 31a is connected to the handle 30. The first surface 31a is a slope or a curved surface and is connected to one end of the handle 30. In this embodiment, the first surface 31a is directly connected to the handle 30 without a sub surface 30a (namely, directly connected to an upper end surface of the handle 30). In other embodiments, the first surface 31a can also be connected to the sub surface 30a of the handle 30 (namely, a distance is reserved between the first surface 31a and the upper end surface of the handle 30).

A shutter button 40 is arranged on the first surface 31a of the step part 31. The shutter button 40 is connected to a wireless connection module 50 arranged inside the handle 30. A battery module is further arranged inside the step part 31. The battery module is electrically connected to the wireless connection module 50 to supply power to the wireless connection module 50. A battery 60 in the battery module in this embodiment uses a button cell. For ease of battery replacement, in this embodiment, the battery module is detachably mounted on the step part 31. The battery module includes a mounting component 80 detachably mounted on the step part 31 and the battery 60. The step part 31 is provided with a mounting port 35. Specifically, the mounting port 35 is provided in a side surface of the step part 31, and the mounting component 80 is arranged inside an inner cavity of the step part 31. The mounting component 80 includes a mounting plate 81 for mounting the battery 60, and a cover plate 82 connected to the mounting plate 81. The cover plate 82 is arranged at the mounting port 35 to achieve sealing. In order to facilitate removal of the mounting component 80, a bevel notch is further arranged at the mounting port 35, which is convenient for removal. In this embodiment, the mounting component 80 is detachably mounted on the step part 31. Specifically, a fixing member 36 is arranged inside the handle 30. The fixing member 36 is connected to an inner wall of the handle 30 to bear the mounting component 80.

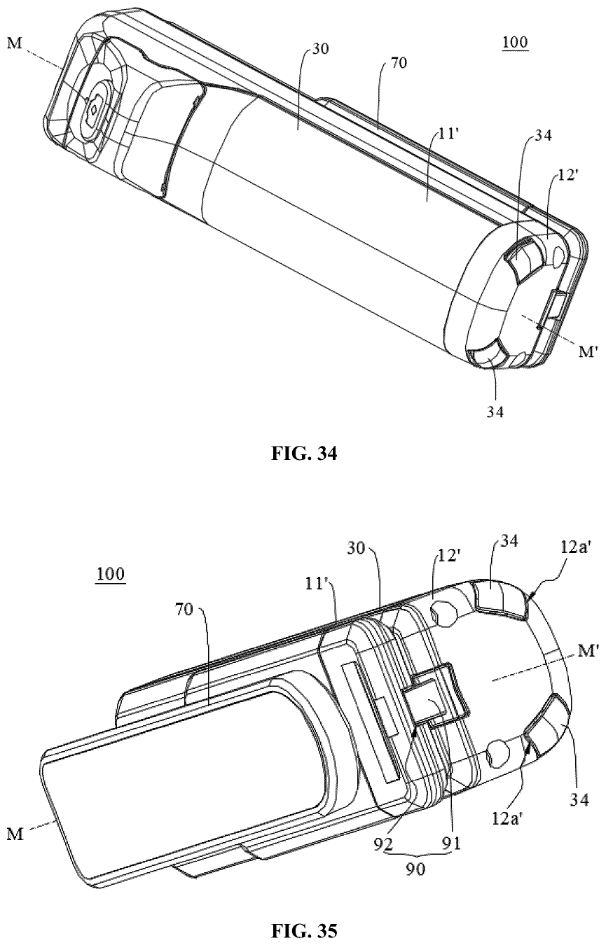

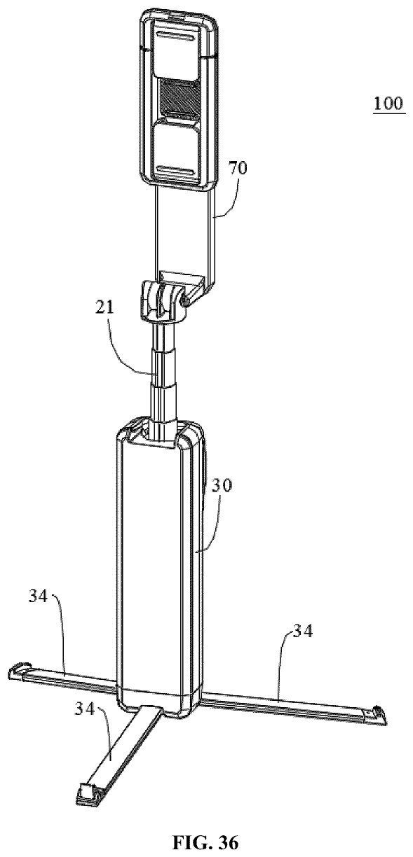

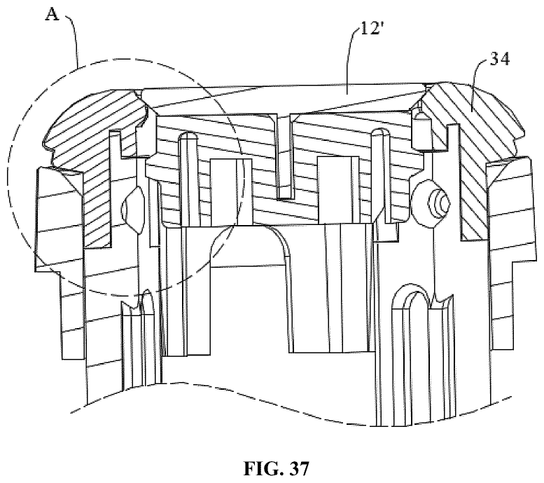

As shown in FIG. 34 to FIG. 40, the present disclosure provides a selfie stick 100 convenient for being operated with an index finger. A handle 30 includes a side wall 11′ and an end wall 12′ connected to the side wall 11′. The side wall 11′ and the end wall 12′ are jointly enclosed to form an accommodating cavity. The end wall 12′ has an opening 12a′ communicated with the accommodating cavity. The end wall 12′ further has a first abutting surface 12b′ facing away from the opening 12a′, and a second abutting surface 12c′ facing the opening 12a′. The handle 30 further includes a supporting leg 34. The supporting leg 34 is movably connected to the side wall 11′ and the end wall 12′. A first end 20a′ of the supporting leg 34 abuts against the first abutting surface 12b′ to limit movement of the supporting leg 34 relative to a direction in which the end wall 12′ extends out of the opening 12a′, to locate the supporting leg 34 in a storage state. A second end 20b′ of the supporting leg 34 abuts against the second abutting surface 12c′, to limit movement of the supporting leg 34 relative to a direction in which the end wall 12′ extends into the opening 12a′, to locate the supporting leg 34 in a supporting state. The first end 20a′ and the second end 20b′ are two ends of the supporting leg 34 that are away from each other. The supporting leg 34 can switch between the storage state and the supporting state.

The side wall 11′ and the end wall 12′ are jointly enclosed to form the accommodating cavity. The end wall 12′ and the side wall 11′ can be of an integrated structure or be of split structures. For example, when the end wall 12′ and the side wall 11′ are of the integrated structures, the end wall 12′ can be integrated with the side wall 11′ through, but not limited to, injection molding or 3D printing. For another example, when the end wall 12′ and the side wall 11′ are of the split structures, the end wall 12′ can be connected to the side wall 11′ in a detachable manner through at least one of screwing, clamping, or plugging, and the end wall 12′ can also be connected to the side wall 11′ in a non-detachable manner through riveting or gluing.

The first end 20a′ of the supporting leg 34 abuts against the first abutting surface 12b′ to limit the movement of the supporting leg 34 relative to the direction in which the end wall 12′ extends out of the opening 12a′, to locate the supporting leg 34 in the storage state. The supporting leg 34 has the storage state. In the storage state, the supporting leg 34 is stored in the accommodating cavity. Furthermore, the first end 20a′ of the supporting leg 34 abuts against the first abutting surface 12b′ to limit the movement of the supporting leg 34 relative to the direction in which the end wall 12′ extends out of the opening 12a′.

The second end 20b′ of the supporting leg 34 abuts against the second abutting surface 12c′, to limit the movement of the supporting leg 34 relative to a direction in which the end wall 12′ extends into the opening 12a′, to locate the supporting leg 34 in the supporting state. The supporting leg 34 has the supporting state. In the supporting state, the supporting leg 34 extends out of the accommodating cavity. Furthermore, the second end 20b′ of the supporting leg 34 abuts against the second abutting surface 12b′ to limit the movement of the supporting leg 34 relative to the direction in which the end wall 12′ extends into the opening 12a′.

The first end 20a′ and the second end 20b′ are two ends of the supporting leg 34 that are away from each other. The supporting leg 34 can switch between the storage state and the supporting state. It should be noted that the switching process of the supporting leg 34 between the storage state and the supporting state can be manually or automatically implemented. For example, when the switching process of the supporting leg 34 between the storage state and the supporting state is manually implemented, a user directly pulls the supporting leg 34 outwards to cause the supporting leg 34 to extend out of the accommodating cavity, so that the supporting leg 34 switches from the storage state to the supporting state. On the contrary, the user directly pushes the supporting leg 34 inwards to cause the supporting leg 34 to extend into the accommodating cavity, so that the supporting leg 34 switches from the supporting state to the storage state. For another example, when the switching process of the supporting leg 34 between the storage state and the supporting state is automatically implemented, a user triggers a button, making a controller of the selfie stick 100 control a power source to actuate a transmission mechanism to drive the supporting leg 34 to move in the direction of extending out of the opening 12a′, so that the supporting leg 34 extends out of the accommodating cavity, and switches from the storage state to the supporting state. On the contrary, the user triggers the button, making the controller of the selfie stick 100 control the power source to actuate the transmission mechanism to drive the supporting leg 34 to move in the direction of extending into the opening 12a′, so that the supporting leg 34 extends into the accommodating cavity, and switches from the supporting state to the storage state. Specific manifestations of the power source and the transmission mechanism are not limited here, and designers can make proper designs according to actual needs. In addition, when the switching process of the supporting leg 34 between the storage state and the supporting state is automatically implemented through the above power source and the above transmission mechanism, if the supporting leg 34 is in the storage state, the first abutting surface 12b′ plays a limited supporting role on the first end 20a′ of the supporting leg 34, so that an acting force of the supporting leg 34 is not completely borne by the transmission mechanism and the power source; and if the supporting leg 34 is in the supporting state, the second abutting surface 12c′ plays a limited supporting role on the second end 20b′ of the supporting leg 34, so that the acting force of the supporting leg 34 is not completely borne by the transmission mechanism and the power source. This can reduce mechanical losses of both the transmission mechanism and the power source, and prolong service lives of the transmission mechanism and the power source.

Based on the selfie stick 100 convenient for being operated with the index finger in this embodiment of the present disclosure, when the supporting leg 34 is stored in the accommodating cavity, the first end 20a′ of the supporting leg 34 abuts against the first abutting surface 12b′, and the first abutting surface 12b′ faces away from the opening 12a′. Therefore, the first abutting surface 12b′ plays a limiting role on the supporting leg 34 in the movement direction of extending out of the opening 12a′, so that the supporting leg 34 can be stably located in the storage state of being stored in the accommodating cavity, and it is not easy to loosen the supporting leg 34. In this case, an overall space occupancy rate of the selfie stick 100 is small, which is convenient for storage by a user. When the supporting leg 34 extends out of the accommodating cavity, the second end 20b′ of the supporting leg 34 abuts against the second abutting surface 12c′, and the second abutting surface 12c′ faces the opening 12a′. Therefore, the second abutting surface 12c′ plays a limiting role on the supporting leg 34 in the movement direction of extending into the opening 12a′, so that the supporting leg 34 can be stably located in the supporting state of extending out of the accommodating cavity, and the supporting leg 34 is not easily loosened and can be stably supported on a surface to be touched, which provides a stable support for photographing equipment. It is convenient for a user to free the hands and perform long-distance photographing.

As shown in FIG. 41, the end wall 12′ includes a first wall plate 121′, a second wall plate 122′ that is arranged around a circumferential direction of the first wall plate 121′ and that is connected to the first wall plate 121′, and a third wall plate 123′ connected to one side of the first wall plate 121′ facing the side wall 11′. The third wall plate 123′ is spaced apart from the second wall plate 122′ to form a movement gap through which the supporting leg 34 moves. The first wall plate 121′ has the opening 12a′ in a region corresponding to the movement gap, and the first wall plate 121′ has the first abutting surface 12b′ at a position adjacent to an edge of the opening 12a′. The third wall plate 123′ has the second abutting surface 12c′ at a position corresponding to the opening 12a′.

The second wall plate 122′ and the first wall plate 121′ can be formed into an integrated structure through, but not limited to, injection molding or 3D printing. The third wall plate 123′ and the first wall plate 121′ can be of an integrated structure or split structures. For example, when the third wall plate 123′ and the first wall plate 121′ are of the integrated structure, the third wall plate 123′ can be integrated with the first wall plate 121′ through, but not limited to, injection molding or 3D printing. For another example, when the third wall plate 123′ and the first wall plate 121′ are of the split structures, the third wall plate 123′ can be connected to the first wall plate 121′ in a detachable manner through at least one of screwing, clamping, or plugging, and the third wall plate 123′ can also be connected to the first wall plate 121′ in a non-detachable manner through, but not limited to, riveting or gluing.

When the supporting leg 34 is in the storage state of being stored in the accommodating cavity, the first end 20a′ of the supporting leg 34 abuts against the first abutting surface 12b′ of the first wall plate 121′. Therefore, the first abutting surface 12b′ plays a limiting role on the supporting leg 34 in the movement direction of extending out of the opening 12a′, so that the supporting leg 34 can be stably located in the storage state of being stored in the accommodating cavity. In this case, an overall space occupancy rate of the selfie stick 100 is small, which is convenient for storage by a user. When the supporting leg 34 is in the supporting state of extending out of the accommodating cavity, the second end 20b′ of the supporting leg 34 abuts against the second abutting surface 12c′ of the third wall plate 123′, and the second abutting surface 12c′ plays a limiting role on the supporting leg 34 in the movement direction of extending into the opening 12a′, so that the supporting leg 34 can be stably located in the supporting state of extending out of the accommodating cavity. In this case, the selfie stick 100 can be in contact with a surface to be touched through the supporting leg 34. It is convenient for a user to free the hands and perform long-distance photographing.

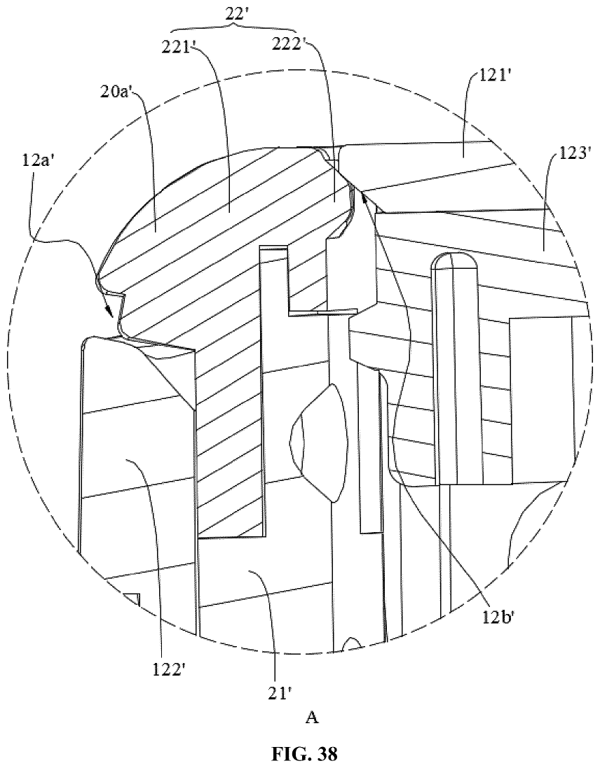

As shown in FIG. 34 and FIG. 38, the handle 30 defines a central axis MM′, and a distance between the first abutting surface 12b′ and the central axis MM′ gradually decreases from one side close to the opening 12a′ to one side away from the opening 12a′. The supporting leg 34 includes a rod body 21′ and a seat body 22′. The rod body 21′ is movably connected to the side wall 11′ and the end wall 12′. The seat body 22′ serves as the first end 20a′ of the supporting leg 34, which is connected to a bottom end of the rod body 21′. When the supporting leg 34 is located in the above storage state, the seat body 22′ abuts against the first abutting surface 12b′.

A specific connection between the seat body 22′ and the rod body 21′ is not limited here, and designers can make proper designs according to actual needs. For example, the seat body 22′ can be detachably connected to the rod body 21′ through, but not limited to, at least one of screwing, clamping, or plugging. For another example, the seat body 22′ can also be non-detachably connected to the rod body 21′ through, but not limited to, gluing, riveting, injection molding, or 3D printing.

By designing the first abutting surface 12b′ as a slope, it is possible to ensure that the first abutting surface 12b′ plays an effective limiting role on the seat body 22′ in the movement direction of extending out of the opening 12a′, so that the supporting leg 34 can be stably located in the storage state of being stored in the accommodating cavity. Furthermore, it is convenient to smoothly release the seat body 22′ from the limitation of the first abutting surface 12b′ under an external force, so that the supporting leg 34 can switch from the storage state to the supporting state.

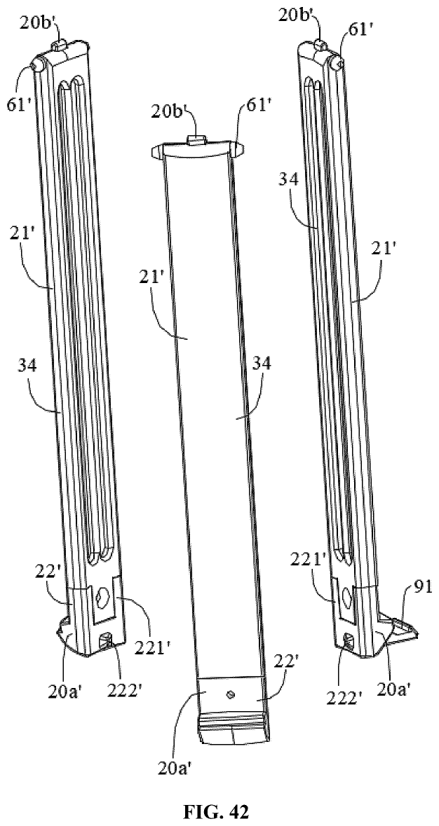

Specifically, as shown in FIG. 42, a specific design of the seat body 22′ and a specific connection between the seat body 22′ and the rod body 21′ can include, but are not limited to, one or more of the following situations.

In a first situation, the seat body 22′ includes a leg seat 221′ and a first abutting protrusion 222′. The leg seat 221′ is connected to the bottom end of the rod body 21′, and the first abutting protrusion 222′ is connected to one side of the leg seat 221′ facing the third wall plate 123′. When the supporting leg 34 is located in the storage state, the first abutting protrusion 222′ abuts against the first abutting surface 12b′. The first abutting protrusion 222′ is integrally formed with the leg seat 221′ through injection molding or 3D printing. Through the leg seat 221′ and the first abutting protrusion 222′, the leg seat 221′ is configured to achieve the connection between the first abutting protrusion 222′ and the rod body 21′, and the first abutting protrusion 222′ is configured to abut against the first abutting surface 12b′. The design of the first abutting protrusion 222′ can ensure effective contact between the first abutting protrusion 222′ and the first abutting surface 12b′ when they abut against each other, so that the first abutting surface 12b′ plays an effective limiting role on the first abutting protrusion 222′ in the movement direction of extending out of the opening 12a′, and the supporting leg 34 can be stably located in the storage state of being stored in the accommodating cavity. Furthermore, under an external force, it is convenient for the leg seat 221′ to drive the first abutting protrusion 222′ to be smoothly released from the first abutting surface 12b′, so that the supporting leg 34 can switch from the storage state to the supporting state.

In a second situation, the seat body 22′ is detachably connected to the rod body 21′. A via hole is provided in a bottom end of the rod body 21′. The seat body 22′ is provided with a fixing hole corresponding to the via hole. The supporting leg 34 further includes a fastener (not shown). The fastener is threaded into the via hole and is connected to the fixing hole, to fix the seat body 22′ to the rod body 21′. For example, the fixing hole can be a threaded hole. In this case, the fastener is a screw. The screw is threaded into the via hole and is in threaded connection with the threaded hole, to fix the seat body 22′ to the rod body 21′. For another example, the fixing hole can be a clamping hole. In this case, the fastener is a clamping pin. The clamping pin is threaded into the via hole and is in snap-in connection with the clamping hole, to fix the seat body 22′ to the rod body 21′. For still another example, the fixing hole can also be a plugging hole. In this case, the fastener is a bolt. The bolt is threaded into the via hole and is in plugged connection with the plugging hole, to fix the seat body 22′ to the rod body 21′. By designing the detachable connection between the seat body 22′ and the rod body 21′, it is convenient for replacement of the seat body 22′ after the seat body is worn, thereby ensuring that the supporting leg 34 can be stably supported on the surface to be touched.

In a third situation, the seat body 22′ is elastic. A material for preparing the seat body 22′ can be, but is not limited to, elastic rubber or elastic silicone. By designing the seat body 22′ to be elastic, on the one hand, the elastic seat body 22′ has a buffering and shock-absorbing effect, which can reduce shaking of the selfie stick 100 during long-distance photographing, thereby improving quality of a captured image. On the other hand, the elastic seat body 22′ has a large static friction force with the surface to be touched, which can improve stability of placing the selfie stick 100 on the surface to be touched during long-distance photographing.

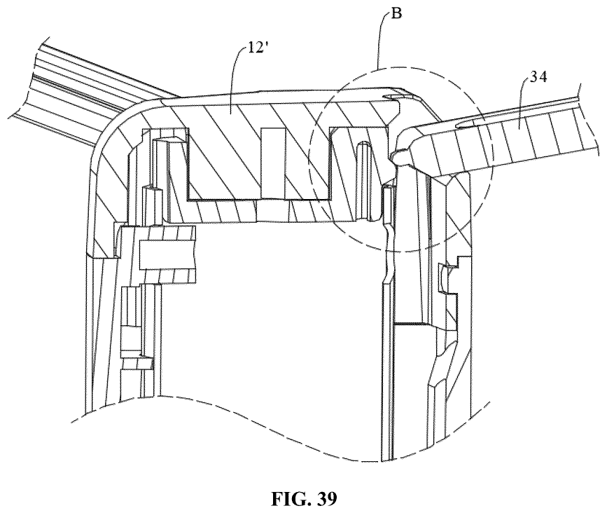

As shown in FIG. 39 to FIG. 41, the third wall plate 123′ includes a plate body 1231′, a cantilever 1232′, and a second abutting protrusion 1233′. The plate body 1231′ is connected to the first wall plate 121′, and a peripheral surface of the plate body 1231′ is inwards recessed at a position corresponding to the opening 12a′ to form another avoidance slot 1234′. The cantilever 1232′ is located in another avoidance slot 1234′, and one end is connected to the plate body 1231′. The second abutting protrusion 1233′ is connected to one side of the cantilever 1232′ facing the second wall plate 122′, and a surface of the second abutting protrusion 1233′ facing the opening 12a′ serves as the above second abutting surface 12c′.

The plate body 1231′, the cantilever 1232′, and the second abutting protrusion 1233′ can be integrally formed through, but not limited to, injection molding or 3D printing. A distance between the second abutting surface 12b′ and the central axis MM′ of the handle 30 gradually increases from one side close to the opening 12a′ to one side away from the opening 12a′.

By designing the second abutting protrusion 1233′, the second abutting surface 12c′ of the second abutting protrusion 1233′ is in effective contact with the second end 20b′ of the supporting leg 34, which can ensure that the second abutting surface 12c′ plays an effective limiting role on the supporting leg 34 in the movement direction of extending out of the opening 12a′, so that the supporting leg 34 can be stably located in the supporting state of extending out of the accommodating cavity. By designing the cantilever 1232′, the cantilever 1232′ is suitable for generating elastic deformation under the pressing action of the second end 20b′ of the supporting leg 34, so as to drive the second abutting surface 12c′ of the second abutting protrusion 1233′ to be smoothly separated from the second end 20b′ of the supporting leg 34, so that the supporting leg 34 switches from the supporting state to the storage state. By designing the another avoidance slot 1234′, the another avoidance slot 1234′ can provide a sufficient avoidance space for the elastic deformation of the cantilever 1232′.

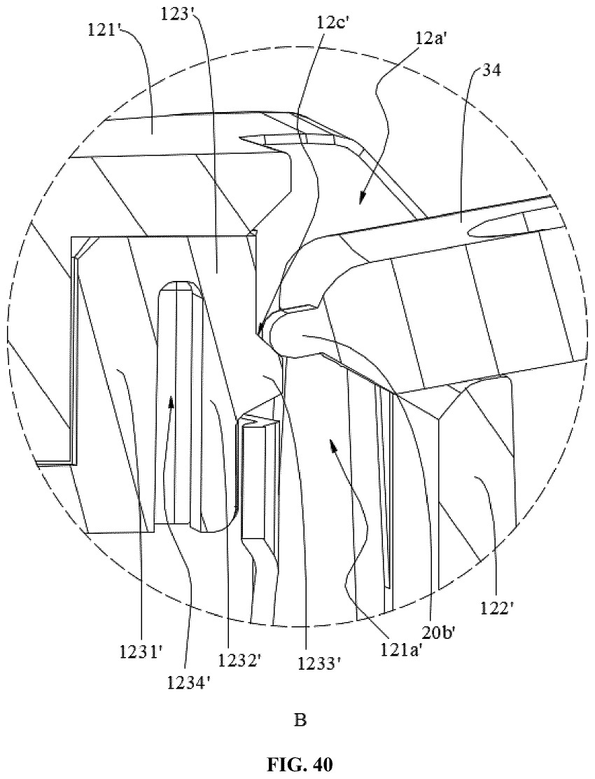

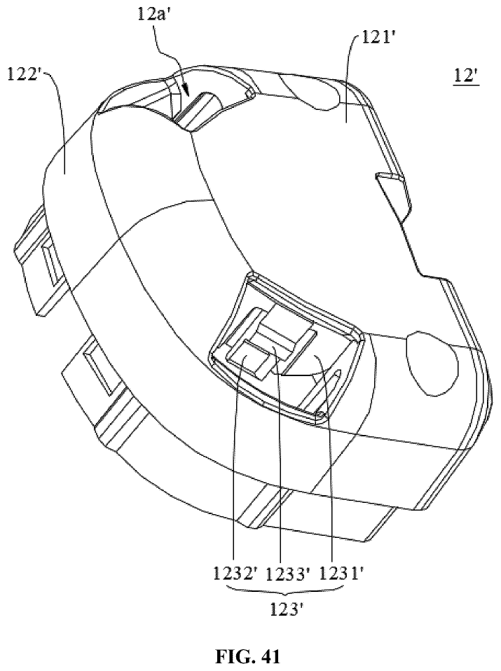

It should be noted that the first wall plate 121′ is provided with a guide slot 121a′ (shown in FIG. 40) in a position corresponding to the opening 12a′. A guide column 61′ (shown in FIG. 42) is arranged at the second end 20b′ of the supporting leg 34. When the supporting leg 34 moves in the direction of extending out of the opening 12a′ to make the guide column 61′ be in contact with a bottommost end of the guide slot 121a′, the supporting leg 34 rotates away from the central axis MM′ of the handle 30 by using an axis of the guide column 61′ as a rotation center, until the second end 20b′ of the supporting leg 34 abuts against the second abutting surface 12c′ of the second abutting protrusion 1233′, thereby locating the supporting leg 34 in the supporting state. On the contrary, the supporting leg 34 rotates towards the central axis MM′ of the handle 30 by using the axis of the guide column 61′ as the rotation center, until the second end 20b′ of the supporting leg 34 is separated from the second abutting surface 12c′ of the second abutting protrusion 1233′. Afterwards, the supporting leg 34 can move in the direction of extending into the opening 12a′, until the first end 20a′ of the supporting leg 34 abuts against the first abutting surface 12b′, thereby locating the supporting leg 34 in the storage state.

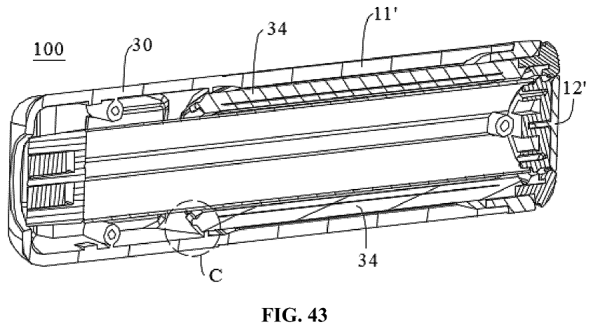

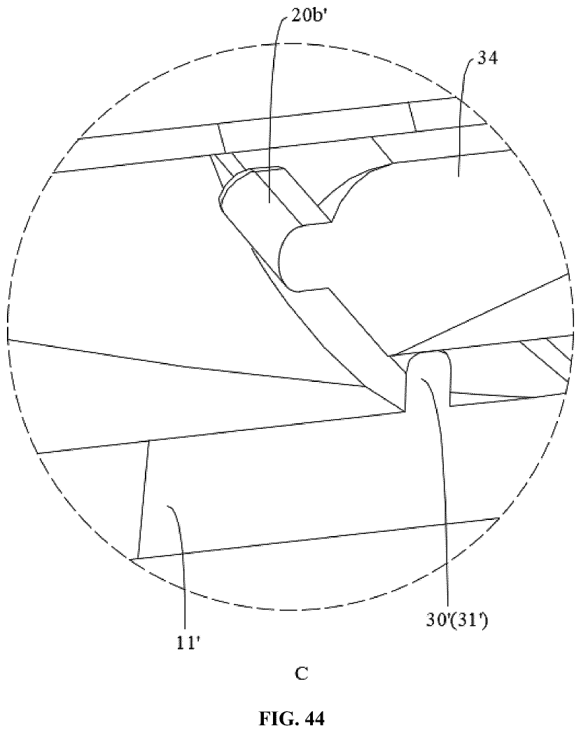

As shown in FIG. 43 to FIG. 44, the selfie stick 100 further includes a limiting structure 30′. The limiting structure 30′ is arranged on at least one of the side wall 11′ and the supporting leg 34. When the supporting leg 34 is in the storage state, the limiting structure 30′ is configured to limit the movement, relative to the end wall 12′, of the supporting leg 34 in the direction of extending out of the opening 12a′. By designing the limiting structure 30′, when the supporting leg 34 is in the storage state, the limiting structure 30′ is configured to limit the movement, relative to the end wall 12′, of the supporting leg 34 in the direction of extending out of the opening 12a′, to cooperate with the limiting effect of the first abutting surface 12b′ on the first end 20a′ of the supporting leg 34 to achieve a dual limiting effect on the supporting leg 34, which can effectively improve the stability of the supporting leg 34 in the accommodating cavity when the supporting leg 34 is in the storage state.

Specifically, a specific manifestation of the limiting structure 30′ and a specific arrangement position of the limiting structure 30′ can include, but are not limited to, one or more of the following situations.

In a first situation, the limiting structure 30′ includes a limiting flange 31′. The limiting flange 31′ is connected to the side wall 11′. When the supporting leg 34 is in the storage state, the limiting flange 31′ presses against the supporting leg 34, so that the supporting leg 34 can remain stationary relative to the end wall 12′ under the action of a static friction force between the supporting leg 34 and the limiting flange 31′. The limiting flange 31′ can be of a long-strip structure or a point-like structure, which is not limited here. The limiting flange 31′ can be integrally formed with the side wall 11′ through, but not limited to, injection molding or 3D printing. By designing the limiting flange 31′, when the supporting leg 34 is in the storage state, the limiting flange 31′ presses against the supporting leg 34. The static friction force generated between the limiting flange 31′ and the supporting leg 34 can limit the movement, relative to the end wall 12′, of the supporting leg 34 in the direction of extending out of the opening 12a′, to cooperate with the limiting effect of the first abutting surface 12b′ on the first end 20a′ of the supporting leg 34 to achieve a dual limiting effect on the supporting leg 34, which can effectively improve the stability of the supporting leg 34 in the accommodating cavity when the supporting leg 34 is in the storage state.

In a second situation, the limiting structure 30′ includes a limiting flange 31′. The limiting flange 31′ is connected to the supporting leg 34. When the supporting leg 34 is in the storage state, the limiting flange 31′ presses against the side wall 11′, so that the supporting leg 34 can remain stationary relative to the end wall 12′ under the action of a static friction force between the limiting flange 31′ and the side wall 11′. The limiting flange 31′ can be of a long-strip structure or a point-like structure, which is not limited here. The limiting flange 31′ can be integrally formed with the supporting leg 34 through, but not limited to, injection molding or 3D printing. By designing the limiting flange 31′, when the supporting leg 34 is in the storage state, the limiting flange 31′ presses against the side wall 11′. The static friction force generated between the limiting flange 31′ and the side wall 11′ can limit the movement, relative to the end wall 12′, of the supporting leg 34 in the direction of extending out of the opening 12a′, to cooperate with the limiting effect of the first abutting surface 12b′ on the first end 20a′ of the supporting leg 34 to achieve a dual limiting effect on the supporting leg 34, which can effectively improve the stability of the supporting leg 34 in the accommodating cavity when the supporting leg 34 is in the storage state.

Of course, in other situations, the limiting structure 30′ may also include a limiting bayonet pin (not shown). The limiting bayonet pin is arranged on at least one of the side wall 11′ and the supporting leg 34, and at least the other one of the side wall 11′ and the supporting leg 34 is provided with a limiting slot corresponding to the limiting bayonet pin. When the supporting leg 34 is in the storage state, the limiting bayonet pin is clamped with the limiting slot, so that the supporting leg 34 can remain stationary relative to the end wall 12′ under the action of a clamping force between the limiting bayonet pin and the limiting slot.

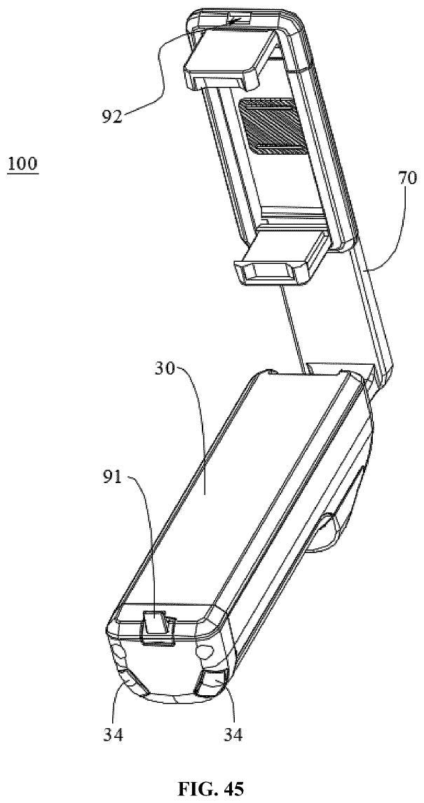

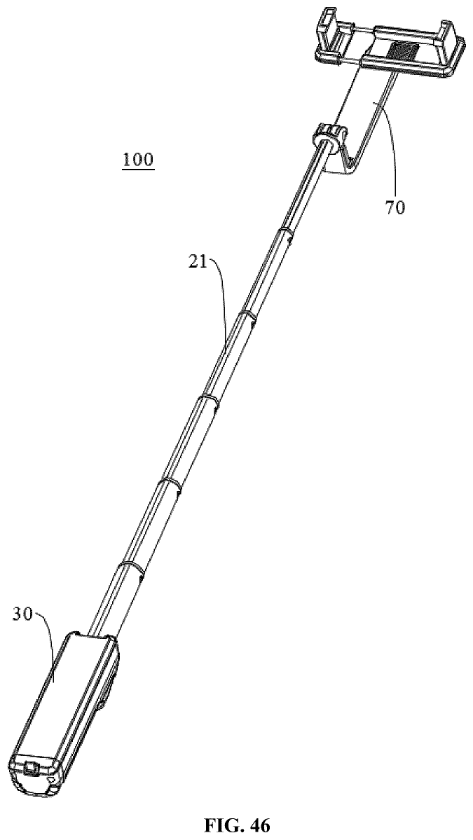

As shown in FIG. 34, FIG. 35, FIG. 45, and FIG. 46, the selfie stick 100 further includes a connecting mechanism (including the above supporting member 70 and the above clamping assembly 10). The connecting mechanism is configured to mount photographing equipment and is rotatably connected to the handle 30, so that the connecting mechanism and the handle 30 can switch between an unfolded use state and a folded non-use state. There are a plurality of supporting legs 34. The first end 20a′ of at least one of the plurality of supporting legs 34 is configured to be locked with the connecting mechanism in the non-use state, to lock the connecting mechanism to the handle 30.

The connecting mechanism and the handle 30 are rotatably connected to each other, so that an opening angle between the connecting mechanism and the handle 30 can be adjusted. There is no limitation on the rotational connection between the connecting mechanism and the handle 30 here, and designers can make proper designs according to actual needs. For example, the handle 30 further includes a telescopic rod 21. The telescopic rod 21 is stored in the above accommodating cavity, and the connecting mechanism is rotatably connected to the telescopic rod 21.

An end of the connecting mechanism close to the rotation center OO′ and an end of the handle 30 close to the rotation center OO′ are first ends of the connecting mechanism and the handle 30. An end of the connecting mechanism away from the rotation center OO′ and an end of the handle 30 away from the rotation center OO′ are second ends of the connecting mechanism and the handle 30. The first ends and the second ends are opposite to each other.

The connecting mechanism and the handle 30 can switch between the unfolded use state and the folded non-use state. The connecting mechanism and the handle 30 are rotated to be unfolded in a manner of facing away from each other, to achieve the use state. In this case, the second end of the connecting mechanism and the second end of the handle 30 move away from each other. The connecting mechanism and the handle 30 are rotated towards each other to be folded, to achieve the non-use state. In this case, the second end of the connecting mechanism and the second end of the handle 30 move close to each other. In this way, when a user needs to take a photo with the selfie stick 100, the user rotates the connecting mechanism and the handle 30 to be unfolded in the manner of facing away from each other and then mounts photographing equipment on the connecting mechanism, to facilitate a photo-taking operation. On the contrary, when the user does not need to take a photo with the selfie stick 100, the user rotates the connecting mechanism and the handle 30 towards each other to be folded, to facilitate storage.

There are a plurality of (two or more) of supporting legs 34. In this embodiment of the present disclosure, there are three supporting legs 34 (including the above first supporting leg 38 and the above second supporting leg 39) to form a tripod structure, so that the entire selfie stick 100 can be stably supported on the surface to be touched through the supporting legs 34.

In this design, the first end 20a′ of at least one of the plurality of supporting legs 34 is configured to be locked with the connecting mechanism in the non-use state, to locate the connecting mechanism to the handle 30. In this way, positions of the connecting mechanism and the handle 30 can be relatively fixed when the connecting mechanism and the handle 30 are in the folded non-use state, and the connecting mechanism and the handle 30 cannot be opened freely, which facilitates storage.

As shown in FIG. 35 and FIG. 45, the selfie stick 100 further includes a locking assembly 90. The locking assembly 90 includes a shackle 91 and a locking notch 92. The shackle 91 is arranged on one of the first end 20a′ of the supporting leg 34 and the connecting mechanism, and the locking notch 92 is provided in the other one of the first end 20a′ of the supporting leg 34 and the connecting mechanism. When the connecting mechanism and the handle 30 are in the above non-use state, the shackle 91 is connected to the locking notch 92 to lock the connecting mechanism to the handle 30.

The locking assembly 90 is used as a locking and unlocking structure of the selfie stick 100 to lock the connecting mechanism to the handle 30 when the connecting mechanism and the handle 30 are in the above non-use state, so as to achieve relative position fixation between the connecting mechanism and the handle 30.

The locking assembly 90 includes the shackle 91 and the locking notch 92. The shackle 91 is arranged at one of the first end 20a′ of the supporting leg 34 and the second end of the connecting mechanism, and the locking notch 92 is provided in the other one of the first end 20a′ of the supporting leg 34 and the second end of the connecting mechanism. For example, the shackle 91 can be arranged at the first end 20a′ of the handle 34, and the locking notch 92 can be provided in the second end of the connecting mechanism. Alternatively, the locking notch 92 can be provided in the first end 20a′ of the handle 34, and the shackle 91 can be arranged at the second end of the connecting mechanism.

By designing the shackle 91 and the locking notch 92, when the connecting mechanism and handle 30 are in the folded non-use state, the shackle 91 and the locking notch 92 are in snap-in connection, to achieve relative position fixation between the connecting mechanism and the handle 30. The structure is simple and is easy to implement.

It is worth mentioning that the plurality of supporting legs 34 can cooperate with each other to form a stable supporting mechanism to be in contact with the surface to be touched, and at least one supporting leg 34 can further cooperate with the shackle 91 (or locking notch 92) to be connected to the locking notch 92 (or shackle 91), so that relative position fixation between the connecting mechanism and the handle 30 can be achieved when the connecting mechanism and the handle 30 are in the folded non-use state, and the connecting mechanism and the handle 30 cannot be opened freely, which facilitates storage.

The present invention provides a selfie stick 100. The selfie stick 100 includes a handle 30, a connecting mechanism, and a locking assembly 90. The handle 30 is configured to be held by a user. The connecting mechanism is configured to mount external equipment 200 and is rotatably connected to the handle 30, so that the connecting mechanism and the handle 30 can switch between an unfolded use state and a folded storage state. The locking assembly 90 is arranged on the connecting mechanism and the handle 30. The locking assembly 90 is configured to lock the connecting mechanism to the handle 30 when the connecting mechanism and the handle 30 are in the storage state. A specific position of the locking assembly 90 on the connecting mechanism and the handle 30 is not limited here. For a specific structure of the connecting mechanism and a specific structure of the locking assembly 90, refer to the description above.

Based on the selfie stick 100 in this embodiment of the present invention, the second end of the connecting mechanism and the second end of the handle 30 are connected by the locking assembly 90, so that relative position fixation between the connecting mechanism and the handle 30 can be achieved when the connecting mechanism and the handle 30 are in the folded storage state. The connecting mechanism and the handle 30 cannot be opened freely, to facilitate storage.

It should be understood that the application of the present invention is not limited to the embodiments mentioned above. Those of ordinary skill in the art can obtain improvements or modifications based on the above descriptions. All such improvements and modifications should fall within the scope of protection of the claims of the present invention.

What is claimed is:

1. A selfie stick convenient for being operated with an index finger, which is configured to support external equipment to take a photo, and comprises:
a clamping assembly having a main surface for facing the external equipment located on a first side, wherein a surface of the clamping assembly located on a second side faces away from the main surface;
a supporting member comprising a base and a first connecting part connected to the base, wherein one end of the base away from the first connecting part is connected to the clamping assembly;
an extension and retraction mechanism comprising an extendable arm and a second connecting part arranged at one end of the extendable arm, wherein the second connecting part is connected to the first connecting part, and the extendable arm is capable of extending and retracting to adjust a length of the selfie stick;
a handle connected to one end of the extendable arm away from the second connecting part for holding, wherein a step part is arranged on a surface of the handle located on the second side; the step part is a protruding structure that protrudes towards the second side; the step part comprises a first surface for abutting against the index finger of a user; the first surface is at least a portion of a surface of the step part close to the second connecting part;
from one side close to the second connecting part to one side away from the second connecting part, a distance between at least a portion of the first surface and an axis of the handle gradually increases, or the first surface is perpendicular to the axis of the handle; and
a shutter button arranged on the first surface and configured to be operated with the index finger of the user to control the external equipment to take a photo.

2. The selfie stick convenient for being operated with the index finger according to claim 1, wherein from the side close to the second connecting part to the side away from the second connecting part, the distance between the first surface and the axis of the handle gradually increases;
the step part further comprises a second surface; the second surface is connected to the first surface and the surface of the handle located on the second side; and from the side close to the second connecting part to the side away from the second connecting part, a distance between the second surface and the axis of the handle gradually decreases.

3. The selfie stick convenient for being operated with the index finger according to claim 1, wherein the first surface is perpendicular to the axis of the handle;
the step part further comprises a second surface; the second surface is connected to the first surface and the surface of the handle located on the second side; and from the side close to the second connecting part to the side away from the second connecting part, a distance between the second surface and the axis of the handle gradually decreases.

4. The selfie stick convenient for being operated with the index finger according to claim 1, wherein from the side close to the second connecting part to the side away from the second connecting part, the distance between the first surface and the axis of the handle gradually increases;
the step part further comprises a second surface and a third surface; the second surface is connected to the first surface; from the side close to the second connecting part to the side away from the second connecting part, a distance between the second surface and the axis of the handle remains unchanged; the third surface is connected to the second surface and the surface of the handle located on the second side; and the third surface is perpendicular to the axis of the handle.

5. The selfie stick convenient for being operated with the index finger according to claim 1, wherein the first surface is perpendicular to the axis of the handle;
the step part further comprises a second surface and a third surface; the second surface is connected to the first surface; from the side close to the second connecting part to the side away from the second connecting part, a distance between the second surface and the axis of the handle remains unchanged; the third surface is connected to the second surface and the surface of the handle located on the second side; and the third surface is perpendicular to the axis of the handle.

6. The selfie stick convenient for being operated with the index finger according to claim 1, wherein the first surface is a cambered surface bending towards or away from the axis of the handle.

7. The selfie stick convenient for being operated with the index finger according to claim 1, wherein the step part is detachably connected to the handle.

8. The selfie stick convenient for being operated with the index finger according to claim 7, wherein the step part comprises a first portion and a second portion; the first portion is connected to the handle; the second portion is detachably connected to the first portion through a positioning structure; and the second portion has the first surface.

9. The selfie stick convenient for being operated with the index finger according to claim 8, further comprising a wireless connection module and a battery module that are arranged at the second part, wherein the wireless connection module is wirelessly connected to the external equipment and controls the external equipment to take a photo through the shutter button; the battery module is electrically connected to the wireless connection module to supply power to the wireless connection module; the battery module comprises a mounting component and a battery that are detachably mounted at the second part; the mounting component comprises a mounting plate and a cover plate connected to the mounting plate; the step part is provided with a mounting port; the cover plate is covered at the mounting port; and the battery is arranged on the mounting component.

10. The selfie stick convenient for being operated with the index finger according to claim 1, wherein the supporting member and the clamping assembly form a connecting mechanism; the first connecting part is rotatably connected to the second connecting part, so that when the extendable arm is in a retracted state and is at least partially located in the handle, the connecting mechanism and the handle are able to switch between an unfolded use state and a folded storage state; an end of the connecting mechanism close to the first connecting part and the second connecting part and an end of the handle close to the first connecting part and the second connecting part are first ends of the connecting mechanism and the handle; an end of the connecting mechanism away from the first connecting part and the second connecting part and an end of the handle away from the first connecting part and the second connecting part are second ends of the connecting mechanism and the handle; the first ends and the second ends are opposite to each other;
the selfie stick further comprises a locking assembly; the locking assembly comprises a shackle and a locking notch; the shackle is arranged at one of the second end of the connecting mechanism and the second end of the handle; the locking notch is provided in the other one of the second end of the connecting mechanism and the second end of the handle; and when the connecting mechanism and the handle are in the storage state, the shackle is connected to the locking notch to lock the connecting mechanism to the handle.

11. The selfie stick convenient for being operated with the index finger according to claim 10, wherein
the supporting member further comprises a rotating member; the clamping assembly comprises an extension and retraction member and two clamping members; the base is rotatably connected to the handle; a mounting space is formed in the base; the rotating member is located in the mounting space and is rotatably connected to the base; the extension and retraction member is located at an end portion of the rotating member and is able to perform extension and retraction motion relative to the rotating member; one clamping member is connected to the rotating member, and the other clamping member is connected to the extension and retraction member; the two clamping members are able to clamp and fix the external equipment from two sides of the external equipment; one end of the extension and retraction member away from the rotating member is used as the second end of the connecting mechanism; and one of the shackle and the locking notch is arranged on the extension and retraction member.

12. The selfie stick convenient for being operated with the index finger according to claim 10, wherein
the supporting member further comprises a rotating member; the clamping assembly comprises an extension and retraction member and two clamping members; the base is rotatably connected to the handle; a mounting space is formed in the base; the rotating member is located in the mounting space and is rotatably connected to the base; the extension and retraction member is located at an end portion of the rotating member and is able to perform extension and retraction motion relative to the rotating member; one clamping member is connected to the rotating member, and the other clamping member is connected to the extension and retraction member; the two clamping members are able to clamp and fix the external equipment from two sides of the external equipment; one end of the rotating member away from the extension and retraction member is used as the second end of the connecting mechanism; and one of the shackle and the locking notch is arranged on the rotating member.

13. The selfie stick convenient for being operated with the index finger according to claim 10, wherein
the supporting member further comprises a rotating member; the clamping assembly comprises an extension and retraction member and two clamping members; the base is rotatably connected to the handle; a mounting space is formed in the base; the rotating member is located in the mounting space and is rotatably connected to the base; the extension and retraction member is located at an end portion of the rotating member and is able to perform extension and retraction motion relative to the rotating member; one clamping member is connected to the rotating member, and the other clamping member is connected to the extension and retraction member; the two clamping members are able to clamp and fix the external equipment from two sides of the external equipment; one end of the base away from a rotation center is used as the second end of the connecting mechanism; and one of the shackle and the locking notch is arranged on the base.

14. The selfie stick convenient for being operated with the index finger according to claim 13, wherein
an avoidance slot is provided in one end of the extension and retraction member away from the rotating member; and when the shackle and the locking notch are in snap-in connection, the shackle is arranged in the avoidance slot.

15. The selfie stick convenient for being operated with the index finger according to claim 10, wherein
the shackle is located in a middle position of the second end of the handle; and the locking notch is located in a middle position of the second end of the connecting mechanism.

16. The selfie stick convenient for being operated with the index finger according to claim 10, wherein
the handle comprises a shell, a first supporting leg, and a second supporting leg; the shell is rotatably connected to the connecting mechanism and has an accommodating cavity; the first supporting leg is movably connected to the shell; the second supporting leg is used as the second end of the handle and is movably connected to the shell; one of the shackle and the locking notch is arranged on the second supporting leg;
the first supporting leg and the second supporting leg have a first state of extending out of the accommodating cavity; the first supporting leg and the second supporting leg further have a second state of being stored inside the accommodating cavity; and the first supporting leg and the second supporting leg are able to switch between the first state and the second state.

17. The selfie stick convenient for being operated with the index finger according to claim 1, wherein the handle comprises a third connecting part and three supporting legs capable of achieving separable supporting; one end of each of the three supporting legs is rotatably connected to the third connecting part; and the step part is arranged on the supporting leg located on the second side.

18. The selfie stick convenient for being operated with the index finger according to claim 1, wherein the handle comprises a side wall and an end wall connected to the side wall; the side wall and the end wall are jointly enclosed to form an accommodating cavity; the end wall has an opening communicated with the accommodating cavity; the end wall further has a first abutting surface facing away from the opening, and a second abutting surface facing the opening;
the handle further comprises a supporting leg; the supporting leg is movably connected to the side wall and the end wall; a first end of the supporting leg abuts against the first abutting surface to limit movement of the supporting leg relative to a direction in which the end wall extends out of the opening, to locate the supporting leg in a storage state; a second end of the supporting leg abuts against the second abutting surface, to limit movement of the supporting leg relative to a direction in which the end wall extends into the opening, to locate the supporting leg in a supporting state; the first end and the second end are two ends of the supporting leg that are away from each other; and the supporting leg switches between the storage state and the supporting state.

19. The selfie stick convenient for being operated with the index finger according to claim 18, wherein the end wall comprises a first wall plate, a second wall plate that is arranged around a circumferential direction of the first wall plate and that is connected to the first wall plate, and a third wall plate connected to one side of the first wall plate facing the side wall; the third wall plate is spaced apart from the second wall plate to form a movement gap through which the supporting leg moves;
the first wall plate has the opening in a region corresponding to the movement gap, and the first wall plate has the first abutting surface at a position adjacent to an edge of the opening; and
the third wall plate has the second abutting surface at a position corresponding to the opening.

20. A selfie stick, comprising:
a handle for being held by a user;
a connecting mechanism configured to mount external equipment and rotatably connected to the handle, to enable the connecting mechanism and the handle to switch between an unfolded use state and a folded storage state; and
a locking assembly arranged on the connecting mechanism and the handle, wherein the locking assembly is configured to lock the connecting mechanism to the handle when the connecting mechanism and the handle are in the storage state.
